(19) United States
(12) Patent Application Publication
(10) Pub. No.: US 2011/0022462 A1
(43) Pub. Date: Jan. 27, 2011

(54) DIGITAL CINEMA NETWORK SYSTEM AND METHOD FOR TARGETING FILMS AND ADVERTISING

(75) Inventors: Aaron P. Collins, Aliso Viejo, CA (US); H. Kaye Dyal, Mission Viejo, CA (US); Jonathan A. Pierce, Hollywood, CA (US)

Correspondence Address: GLOBAL PATENT GROUP - CIC, 1005 Warson Road, Suite 201, ST. LOUIS, MO, 63132, US

(73) Assignee: CHOICE, INC., Aliso Viejo, CA (US)

(21) Appl. No.: 12/791,338

(22) Filed: Jun. 1, 2010

Related U.S. Application Data
(60) Provisional application No. 61/183,136, filed on Jun. 2, 2009.

(51) Int. Cl. G06F 15/16; G06F 21/20; G06Q 30/00

(52) U.S. Cl. 705/14.49; 709/205; 726/4

(57) ABSTRACT

Disclosed herein are systems and methods for the distribution of media content to the public, utilizing an internet community network of subscribers having access to sample content; systems and methods for financing the implementation of digital projection capability in a plurality of theaters; systems and methods for dynamically targeting advertising to an audience based on the brand landscape at a given time in a given place; and systems and methods for progressively encumbering content through licensing as the popularity of content increases.

This application claims the benefit of priority of U.S. provisional application No. 61/183,136, filed Jun. 2, 2009, the disclosure of which is hereby incorporated by reference as if written herein in its entirety.

Man's needs are the same today as they have been for centuries: food, shelter, companionship, transportation and entertainment. As Homo sapiens we devote our entire lives to the pursuit of these five basic needs. Among these, entertainment is the focus of the instant disclosure.

Near the turn of the 20th century, the buggy whip industry was devastated by the industrial revolution. Despite efforts to reduce costs through consolidation and lay-offs, companies that had been around for 250 years were put out of business. The need for transportation never went away, so a more efficient alternative emerged. While many inventions have made man's life easier by eliminating or reducing the time it takes to complete various tasks, the car is considered a disruptive technology because it increased the speed that man could travel, which brought several dramatic changes to our lives. When you consider how many more people are employed by the automobile industry compared to the buggy whip industry, you understand that while disruptive technology may destroy the original business model, they typically give birth to larger more expansive models that in turn give birth to new sub-industries and they create even more jobs than their predecessors.

The entertainment industry is in the throes of a similar revolution. The ubiquification of digital technology in every aspect of modern life has been termed the digital revolution. Practically any kind of information can be digitally encoded and transferred by a computer, and decoded by a receiving computer into content viewable in the original form or in another. Coupled with the global network of interconnected computers known as the internet, information can be nearly anywhere almost instantaneously, and information availability to individuals around the world has increased exponentially and continues to do so. This in turn has fundamentally changed the way people live their lives, including how they meet their basic needs, including their needs for companionship and entertainment.

In the entertainment industry, the digital revolution had been a similar disruptive technology. Prior to the financial crash on Wall Street, the film industry was already caught in the kind of “freefall” that only occurs when the financial rug has been pulled out from under the feet of an industry. For about 90 years the film industry has based its value on a familiar and proven financial model, in which film financing and distribution has been almost the exclusive domain of major studios. With the introduction of the internet, however, filmed content is now digitized and exhibited on multiple devices including ones that fit in a person's hand. The pace of change is accelerating towards platform independence (or put another way, ubiquity) in a way unimaginable just 10 years ago.

The file sharing nature of the internet was designed to leverage digital content such as film in exactly this manner. The final result is a mature industry trying to control the dissemination of its product to its customers and no longer being able to do so. As a result of this paradigm shift, there has been a disruption in the financial models that sustained the industry for the past 100 years. Needless to say, it is utter chaos for those who have been hired to convert old legacy systems and outdated business processes of the past with these revolutionary new methods. The industry's inability to conform quickly to these new realities has created an unstable environment called “free fall”. The financial effects caused by these new realities have crept into the film industries financial model and threatens its very foundation. To make matters worse, just as the entertainment industry entered the advanced stages of freefall, the sub-prime driven financial crisis put industry Executives in the worst position of all, an unstable investment environment.

Industry free fall ends the same way all falls end, at a bottom. It often takes several years for a bottom to be reached, because stalwarts of the industry try to hold on to their power one department at a time. In the end, the result is always the same, new laws and reactionary resistance is created, which only serve to delay the inevitable, the impact a disruptive technology brings to its designated industry. One need only look at the music industry to see the disruptive effects the internet and file sharing technology have already had on the entertainment industry.

The digital revolution is no different than any other phenomenon that has fundamentally changed an industry. While many people would argue that the digital revolution has heavily impacted most industries, the actual fact is that few industries have been impacted more than the entertainment industry. The entertainment industry has been completely transformed, from content capture to the dissemination of product to the final consumer, and serious challenges have surfaced.

Due to the nature of the digital revolution, the major studios will not be able to legislate their way out of this situation. The film industry has already begun cost cutting maneuvers with consolidations and lay-offs. However, just like the buggy whip companies, unless the major studios fundamentally change their business model, they will either be put out of business or they will be reincarnated into companies that will barely resemble the previous generations that built the industry. The systems and method disclosed herein will effect a transformation in the way entertainment content is selected and show to the consuming public from a top-down model to a bottom-up one.

### BRIEF DESCRIPTION OF THE DRAWINGS

FIG. 1 of 12 depicts a flow diagram of one embodiment of the system/method disclosed herein for disintermediating the process of entertainment content delivery to consumers. Content is submitted to a content review group (CRG), for example by filmmakers (as shown, or their agents), by movie studios, or by independent distributors. The CRG decides whether or not to add the content to the Network Community Library (content library, NCL) and make the content available through the system to the Internet Community Network (ICN). This decision may be based in part on member requests, psychographic data from one or more users, user search history within the ICN and even external to it, and history of purchases and attendances of exhibitions. Edits to the content may optionally be made. If the decision is made to add the content to the NCL, then sample content, for example trailers and product reels, of new films are provided or created by the filmmakers, the CRG, and/or others for display on the ICN for viewing by members (for example, movie goers). Members are empowered to indicate liking of content or to classify or otherwise “tag” content according to its perceived characteristics. For example, they may optionally be enabled to rate content, recommend or forward it, comment on it, assign or link it to a particular genre, class, or characteristic, and request a showing of the full-length content. Members may also indicate where and when they would most like to see the content exhibited. The overall popularity of a particular piece of content, or its popularity in a geographical region, or amongst fans of a genre of content (say, Genre Y), are each examples of events that may trigger a scheduling of one or more showings of the content. Successful showings (measurable, for example, by attendance of exhibitions) may trigger a feedback loop within the system that notifies the content review group or distributor/administrator of that content's success and the characteristics of that content, and empowers the CRG (as well as participating filmmakers, studios, and others) to more readily provide more content such as that in the future—either to the ICN as a whole, or to a subgroup within it that has displayed an preference for or interest in that type of content.

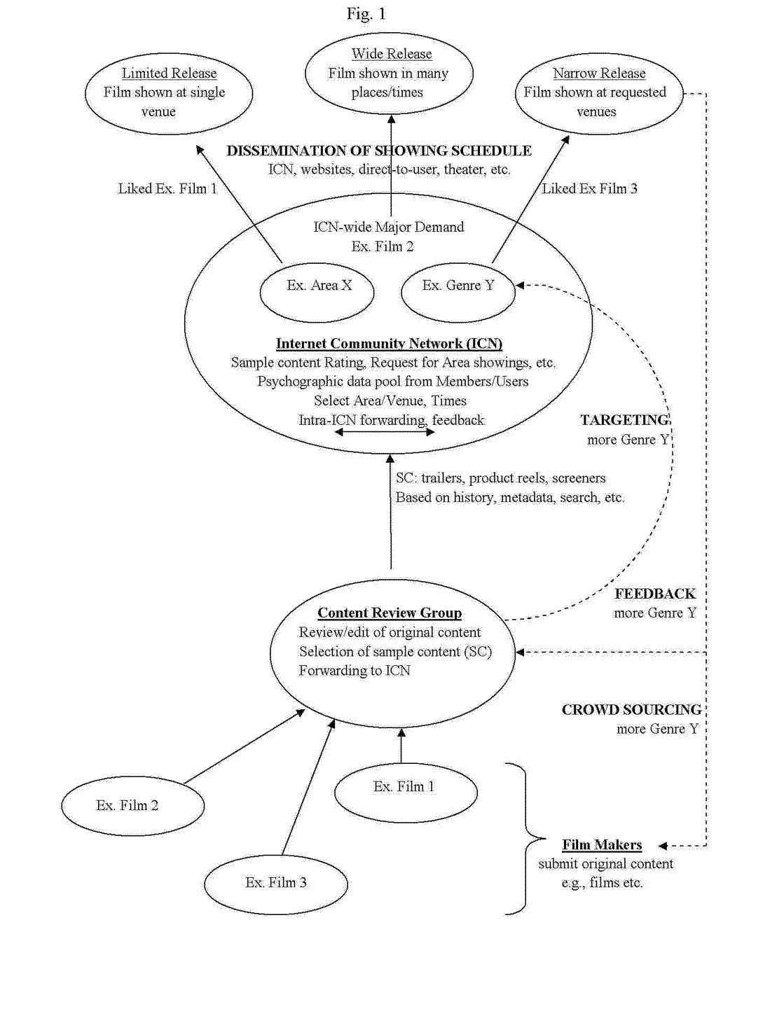

FIG. 2 of 12 depicts a flow diagram of one embodiment of the system for targeted advertising. In it, various advertisers present their ads to the Brand Intelligence Engine, which many be vetted before being made available to viewers. The data on an ad's performance may come from, for example, customer psychographic profiles, regional data, and platform data. The ads are provided to the exhibitor and shown, for example, on a movie screen prior to an exhibition of desired content. After the ads are shown to viewers, advertisers may track their ad's performance.

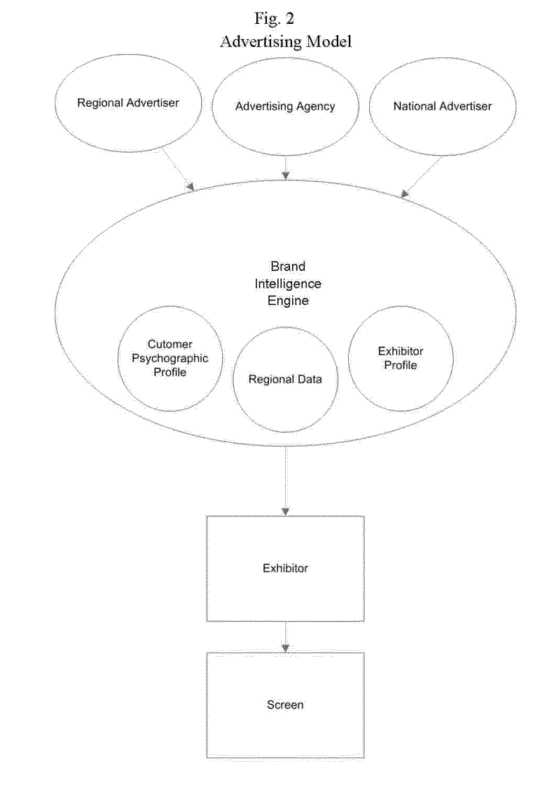

FIG. 3 of 12 depicts many of the sources that would trigger and provide updated information to the metadata of a content/media brand continuum.

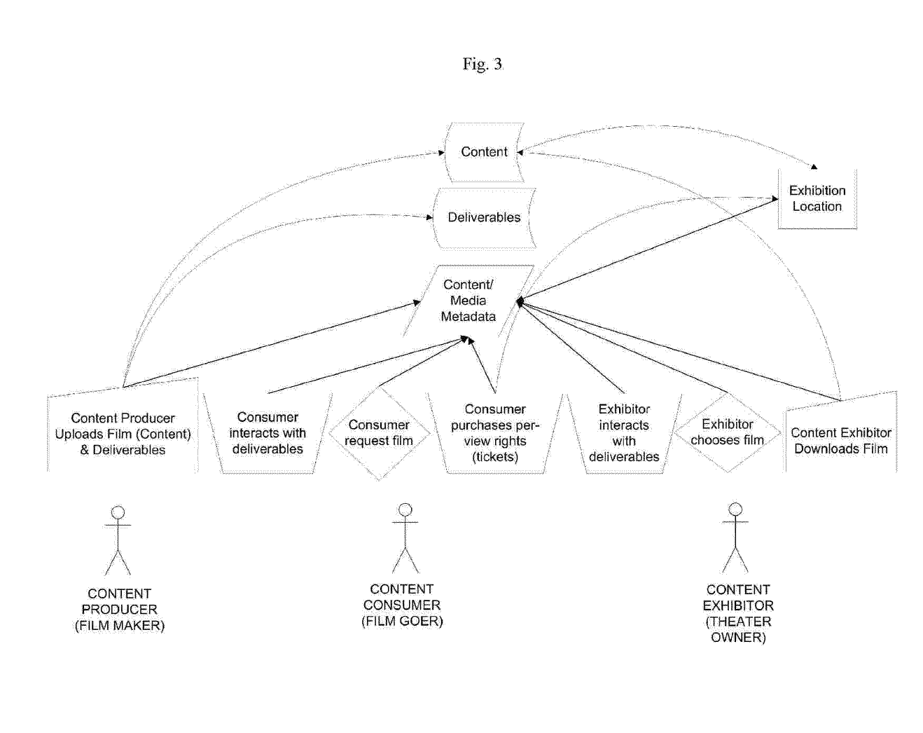

FIG. 4 of 12 depicts many of the sources that would trigger and provide updated information to the metadata of a consumer/individual brand continuum.

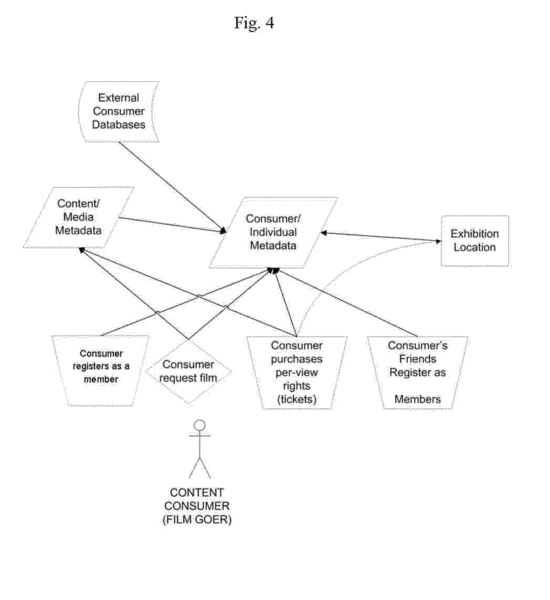

FIG. 5 of 12 depicts many of the sources that would trigger and provide updated information to the metadata of a region/location brand continuum.

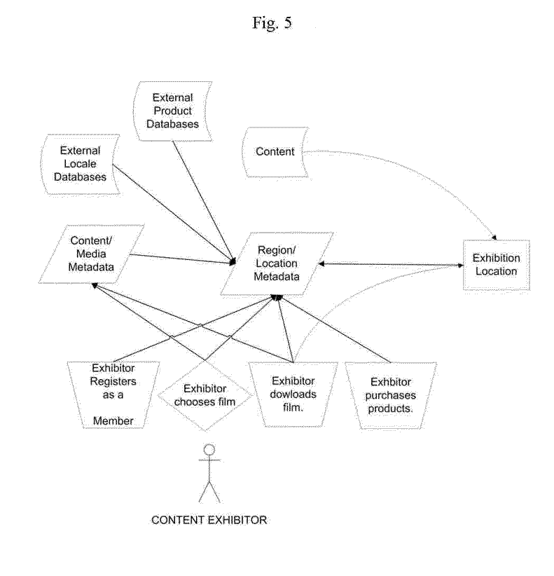

FIG. 6 of 12 depicts how the information from several types of brand continua can overlap. The overlap of all of these brand continua provides an opportunity for targeted marketing.

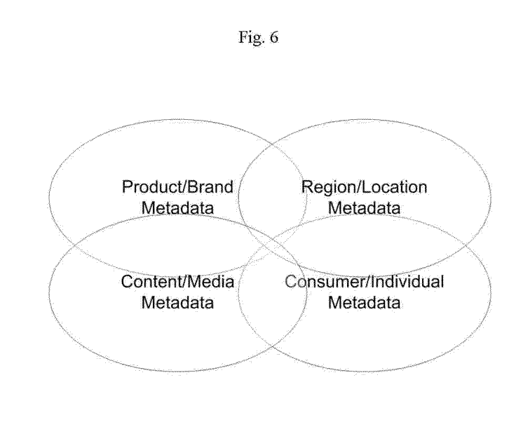

FIG. 7 of 12 depicts how the Brand Intelligence Engine is able to create a “Brand Landscape” from multiple (for example, five in the figure) consumer/individual brand continua in a particular location.

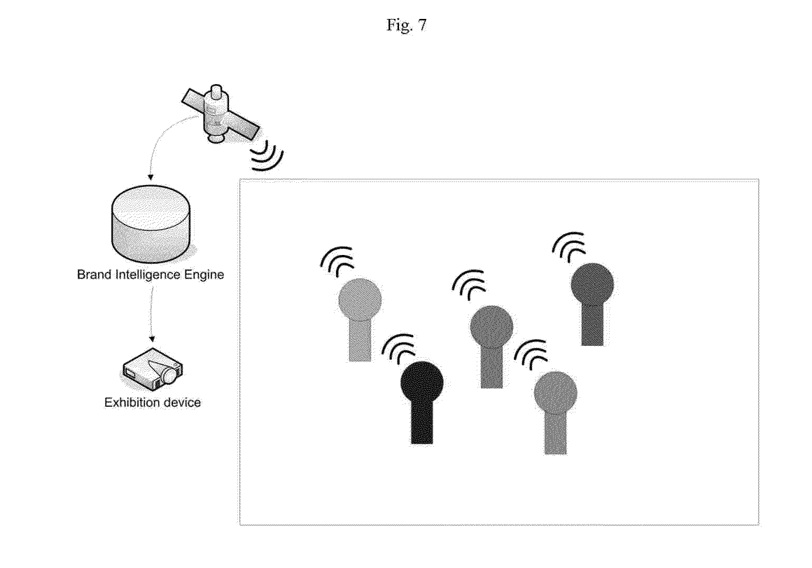

FIG. 8 of 12 depicts how the Brand Intelligence Engine collates metadata for a content/media brand continuum during production.

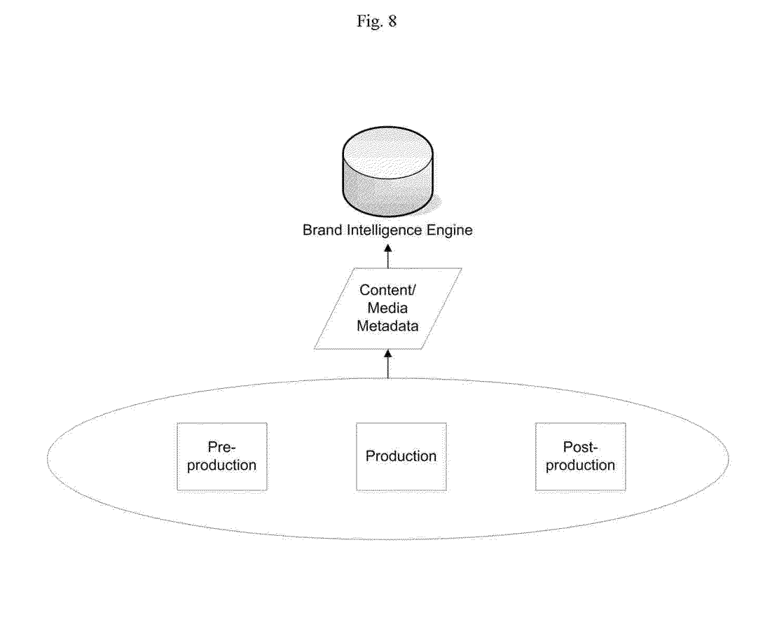

FIG. 9 of 12 depicts a section of content/media as a discreet brand/product continuum. An example of this would be 5 seconds of a film where James Bond is wearing a rolex.

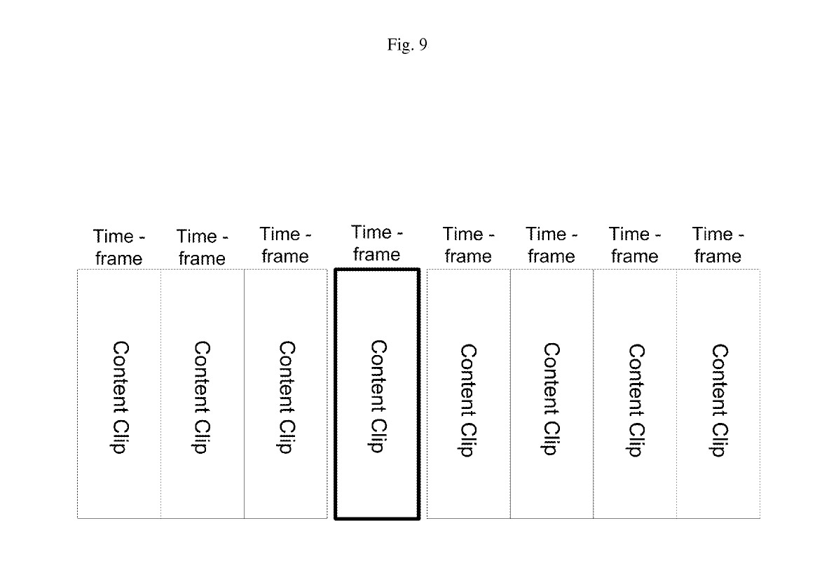

FIG. 10 of 12 depicts the Brand Intelligence Engine utilizing a section of content from the NCL in response to the Brand Landscape of a particular location.

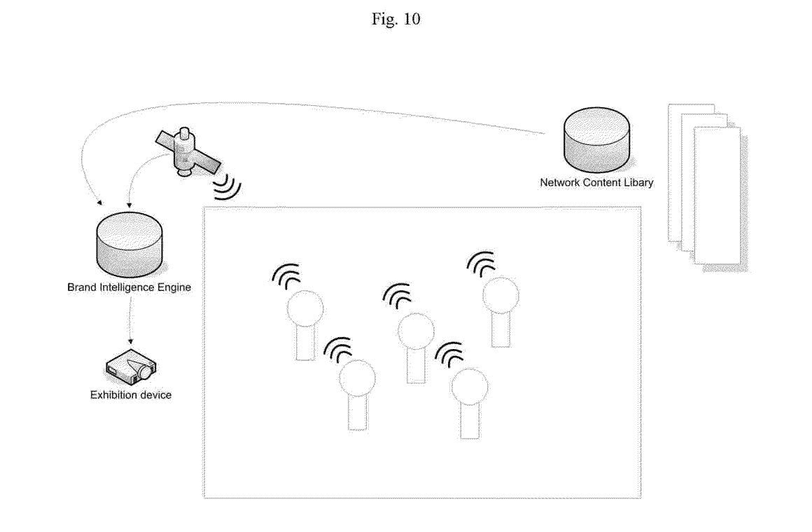

FIG. 11 depicts how content from the NCL can be re-used by individuals or entities in “mash-up” style productions. The content clip provided to such an entity would be provided in a “weighted” fashion by the Brand Intelligence Engine and served up by the NCL.

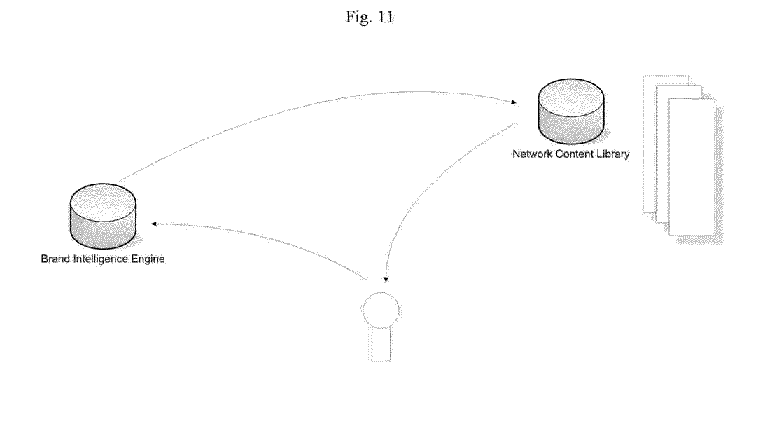

FIG. 12 of 12 depicts one of the ways this engine changes the way the economic processes are changed by the implementation of the Brand Intelligence Engine for advertising. In this example when existing content in a database is “re-branded” based on a dynamic Brand Landscape, the advertiser is charged based on a “per-view” model.

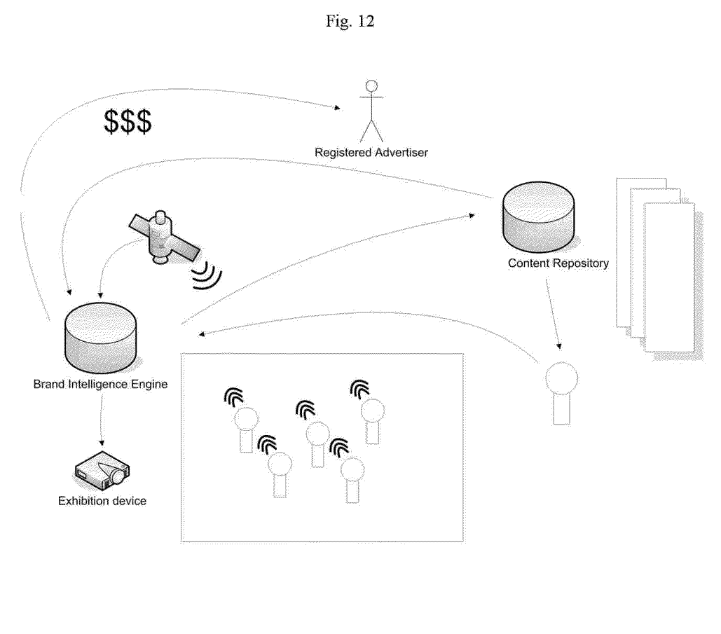

Disclosed herein is a method of content distribution, comprising the following steps in any order:
i. providing a community network to a group of consumers having internet or mobile access, wherein each consumer becomes a member of the network by establishing a profile on the network;
ii. providing to the community network a library of sample content;
iii. providing the ability for members to perceive sample content and indicate favored content; and
iv. based on profile data associated with a plurality of members, together with these members' indicated favored sample content, providing full-length content to an exhibitor in such a way as to make favored content available to consumers.

In certain embodiments, the community network is provided to a group of consumers via a website.

In certain embodiments, the profile on the community network is established by creating a unique identification in the network, then either
i. inputting user-associated data; or
ii. importing user-associated data from an external source available through the internet.

In further embodiments, the data is imported from a social networking site.

In further embodiments, the favored content is indicated by one or more of:
a member's rating of the sample content;
a member's request for exhibition of the content;
a member's forwarding of the sample content to one or more other users;
a member's repeat playing of the sample content; and
an exhibition venue's exhibition of the content.

In further embodiments, the content consists substantially of films.

In further embodiments, the sample content comprises trailers and product reels associated with films which are seeking theatrical distribution status.

In further embodiments, the content is selected by a content review group from amongst content submitted to the group by content creators, distributors, or creator/distributors.

In further embodiments, the sample content is selected by the content review group. In further embodiments, the sample content is produced by:

i. the content creator;

ii. the content distributor;

iii. the content review group; or

iv. any two or more of these entities working together.

In further embodiments, the content creator is a filmmaker, and the content distributor is a movie studio.

In further embodiments, said method has the effect of increasing the number of individual pieces of full-length content exhibited to consumers in a given venue in a given period of time.

In further embodiments, said method has the effect of increasing average attendance of an exhibition at an exhibition venue.

In further embodiments, said method has the effect of reducing the advertising expenditure by a distributor or an exhibitor required to achieve an equivalent level of attendance of an exhibition of the content.

In further embodiments, said content is a film and said exhibition venue is a movie theater.

Also provided is a system for distributing content to consumers, comprising:
i. an community network in which a individual consumers having internet access become members of the network by establishing individual profiles on the network;
ii. a first library of content for provision to exhibitors;
iii. a second library of sample content associated with the first library of content for provision to, and available for perception of and indication of preference for, the internet community network;
iv. a plurality of digital projectors, each in an exhibition venue, linked electronically to said first library; and
v. a functionality for electronically disseminating content to each individual digital projector or exhibition venue.

Also provided is a method of financing the implementation of digital projection capability in a plurality of theaters, comprising the steps of:
i. providing to a plurality of exhibitors digital projection systems for implementation in their theaters, and access to a content library;
ii. charging of a per-screening usage fee to exhibitors each time content from the content library is exhibited via the digital projection system; and
iii. reinvestment of the proceeds from the accumulated fees into a fund for further provision of digital projection systems to subsequent exhibitors;
wherein said method results in an increase in the rate of implementation of digital projection capability in theaters.

In certain embodiments, said method permits theaters which would not otherwise be able to afford to implement digital projection capability to do so.

In certain embodiments, said method additionally results in an increase in the quantity or diversity of content available to theaters which have implemented digital projection systems.

Also provided is a system for advertising to a targeted audience, comprising at least one computer which uses psychographic and demographic data gained from one or more online sources to target advertising in a venue.

In certain embodiments, said venue is an offline venue

In certain embodiments, said offline venue is chosen from a television screen, a movie screen, a billboard, and a virtual environment.

In certain embodiments, the advertisement is targeted to a specific individual present in the offline venue where the ad is shown.

Also provided is a system for advertising to a targeted audience, comprising at least one computer having:
a means for determining the brand landscape in a venue at a given time; and
a means for selecting of content or advertising for presentation to the targeted audience.

In certain embodiments, said venue is an offline venue.

In certain embodiments, said offline venue is chosen from a theater, a billboard, and a virtual environment.

In certain embodiments, the presentation of content or advertising to the user is via a movie screen and occurs:
before the content which the audience has come to see;
during the content which the audience has come to see, via brand integration; or in the lobby.

Also provided is a method of progressive licensing encumbrance, comprising:
the joining of a content owner a community network comprising a plurality of members who are content consumers;
the granting of an initial level of rights in an article of content in exchange for an initial level of exposure via the internet community network; and
as popularity increases to each of one or more pre-determined levels, the attachment of additional rights for additional exposure, wherein said popularity of the content is determined by the community network.

In certain embodiments, said additional rights are chosen from certain theatrical exhibition rights, all theatrical exhibition rights, and home-distribution media rights.

In certain embodiments, said home-distribution media rights are chosen from DVD distribution media rights, television rights, and video game rights.

The following terms have the meanings ascribed below. They may be supplemented with standard terms known in the art to the extent that they are not contradictory; in which case the meaning herein controls.

As used herein “disruptive technology” may refer to a social or technological development that causes a subtle or dramatic social or economic shift in that it (a) replaces, augments or eliminates an existing technology with a more efficient technology (b) replaces, augments or eliminates an existing social convention or pattern with different or more efficient convention. The results of a dramatic social or economic shift created by a disruptive technology is defined by one or more of the following: (a) the elimination of an economic entity or process by means of the disruptive technology (b) the replacement of an economic entity or process by means of the disruptive technology.

As used herein “interacting portions of the market” refer to broadly defined demographic, psychographic, commercial or social groups that consciously or unconsciously interact with other broadly defined demographic, psychographic, commercial or social groups within a broad or specific market.

As used herein, “content creators” or “content producers” (for convenience, the term “film makers” is used interchangeably) refers to individuals, groups, companies and studios in the business, whether profitable or not, of creating media including, but not limited to, the form of motion pictures, television shows, commercials, short films, webisodes, music videos, home videos, slide shows, animations and presentations for the public and private consumption of consumers on any platform including but not limited to theaters, computers, hand held devices, televisions, multimedia advertising screens, and three-dimensional surround projectors.

As used herein, a “content provider” is any one of an individual, group, business, etc that holds the rights to existing content, such as content library owners. A content provider may be a content creator.

As used herein, “exhibitors” refers to individuals, groups, companies and studios in the business of private and public exhibition of media including, but not limited to, the form of motion pictures, television shows, commercials, short films, webisodes, music videos, home videos, slide shows, animations and presentations for the public and private consumption of consumers on any platform including but not limited to theaters, computers, hand held devices, televisions, multimedia advertising screens, and three-dimensional surround projectors, as well as virtual methods of exhibition, such as virtual worlds, like “Second Life” and massively multiplayer online games (MMO, MMOG, MMORPG) such as “World of Warcraft” or “Star Wars—The Old Republic). In this sense the term “content exhibitor” is synonymous with the term “content distributor.”

As used herein, “content consumers” (for convenience, the terms “movie goers” and “film goers” are used interchangeably) refers to individuals and groups who publicly and privately consume media including, but not limited to, the form of motion pictures, television shows, commercials, short films, webisodes, music videos, home videos, slide shows, animations and presentations through visual and other sensory experience from exhibition platforms including but not limited to theaters, computers, hand held devices, televisions, multimedia advertising screens, and three-dimensional surround projectors.

As used herein “disintermediation” describes the process of eliminating an intermediating entity involved in a technological or economic process or system. For instance, in a supply chain flows from entity A through entity B to entity C, and entity B is a process or entity that facilitates the transfer of supply products from entity A to entity C, entity B is the intermediating entity. Introducing a method that allows for the flow of product directly from entity A to entity C disintermediates entity B.

As used herein “Internet Community Network” (:ICN″) or “community network” refers to a structured or semi-structured group of individuals or entities who interact with each other individually or in groups facilitated by internet or other technologies. Internet technologies include but are not limited to computers, cellular phones, laptops, handheld devices and all devices past and not invented yet that communicate via methods including but not limited to modems, dial-up connections, DSL, Cable, broadband, WiFi, Bluetooth, infrared, white band, multi-band and all communication technologies present or not currently invented.

As used herein “Content Review Group” (“CRG”) refers to a group of individuals or entities that evaluate the marketability of a media product

As used herein, “Network Community Library” (“NCL”) means a database of media content or references to media content in any form, digital or otherwise, that an entity holds the right to distribute. The NCL can contain either a digital copy of the content or a reference to the actual content in the case where the Library has not yet digitized the content for delivery by the methods described in this filing.

As used herein, the “distributor/system administrator” or “distributor/administrator”in the entity who se teas it is to license any content that is allowed to enter the Network Community Library.

As used herein “trailer” refers to a short promotional clip of a media production ranging in length from a few seconds to a few minutes, typically about 30 seconds to about 5 minutes.

As used herein “product reel” refers to a promotional clip of a media production ranging in length from about 5 minutes to about 30 minutes that includes scenes from the movie, and may or may not include behind the scenes or documentary footage of the making of the media product.

As used herein “screener” or “film screener” refers to a full length version of a media product (for example a complete version of a content producer's film) created for the purpose of evaluation by a media exhibitor, most often containing a disclaimer imprinted on the product to discourage piracy, and optionally with one or more integrated security devices.

As used herein, “metadata” includes psychographic data, regional data, demographic data, platform data, location data, product data, content data, or any other method that describes existing data.

As used herein, “psychographic data” refers to information that describes an entity's likes, dislikes and decisions beyond general demographic data. For instance, demographic data would describe a consumer entity as “female, 15-25, Northwestern United States.” Psychographic data would describe a consumer entity in terms of likes, dislikes: likes blue, likes dramatic stories, likes dark chocolate, likes pop music.” More importantly, psychographic data is generated by quantifiable actions—decisions—and not by not self-descriptions. A person's choice of a particular product would generate psychographic data about that person's preferences, as opposed to that person self-reporting what his or her preferences are.

As used herein, “psychographic profile” refers to a temporal snapshot of an entity's psychographic data.

As used herein “member profile” refers to the information about an individual member that is either supplied by the member during or after joining the network, or it may imported from elsewhere, such as from another networking site. A member profile may be different from a psychographic profile in that it might not accurately describe a consumer's behavior patterns in terms of likes and dislikes, it describes a what a consumer believes to be their likes and dislikes. The difference is that a psychographic profile is quantitative—it is quantified by actions. For example, a person may believe they like the color orange and may tell all their friends they like the color orange, yet paradoxically their purchases indicate that they buy more blue products than orange products.

As used herein “content” may refer to any form of entertainment media. Examples include films, documentaries, episodes of serial programs, short films, live or recorded performances, music, visual art with or without a soundtrack, and the like.

As used herein to “rate” is to indicate, say on a scale of low to high or least to most, one or more qualities of the content, most often simply “liking” of the content. However, rating can also be quality-specific; for example, content may be rated for violence content, adult themes, zaniness, sadness, novelty, or appeal to a particular genre, gender, or culture, and the like. Ratings may take the form of a simple 1/0 or yes/no form, or of a value along a continuum.

As used herein, the “success” or “performance” of a content distribution campaign (for example, a “showing” of a film or a series of showings) may be measured by, for example, the revenue generated by a particular piece of content, tickets sold to showings of the content, downloads of the content, number of showings, length of theatrical release, etc., or any other measure quantizing demand for the content. Similarly, the “success” of an advertising campaign may be measured by, for example, number of units of the product or service sold to or ordered by consumers, or ordered by distributors, or as above, may also be measured by metadata associated with the product or service. “Product” as used herein includes “content.”

Relatedly, as used herein, a “successful” article of content, such as a film or episode, is one that . . . shows positive profit within a predetermined timeframe of the release of the content.

As used herein “flops” refer to films that fails to return their costs (both in production and marketing) within a predetermined timeframe from release of the film (content).

As used herein, to “increase” means to transform from a lower or smaller to a higher or larger measureable state. Likewise, “decrease” means to transform from a higher or larger to a lower or smaller measureable state.

As used herein, “participating” is synonymous with “member,” both used as adjectives to describe, for example, content consumers, content providers, content distributors, or advertisers.

As used herein, an “offline” venue means a venue that is not online, in the traditional sense of not involving the direct use by a user of a computer connected to the internet. However, this descriptive term should not be construed as excluding venues that are actually quite internet-enabled, since more and more traditionally “offline” venues are in fact increasingly internet-enabled and -connected. For example, a movie theater is traditionally understood as an “offline” venue since people go there and do not need to connect to the internet; however, when a digital projector connected to the DCN as described herein is used in a theater to present content and/or advertising, it is no longer “offline” in the strict traditional sense, especially if, as envisaged herein, there is real-time analysis of the dynamic brand landscape in a theater.

A number of problems cry out for a comprehensive solution in the entertainment industry.

First, at present, there is a huge imbalance in the film industry due to a problem that has been labeled “The Distribution Bottleneck.” Where, as here, a select few entities exert rigid control over one aspect of the supply and demand chain, that industry is throttled, much like it was in the Soviet Union during its centralized economic phase.

During the government controlled economy in the twentieth century Soviet Union, prices were not set by supply and demand, but by a centralized governmental entity. There was a case cited by two Soviet Economists that described a situation regarding the government purchase of moleskins. The Ministers raised the price that was paid for moleskins, which increased the amount of skins that hunters provided. As Nikolai Shmelev and Vladimir Popov reported, “State purchases increased, and now all the distribution centers are filled with these pelts. Industry is unable to use them all, and often they rot in the warehouses before they can be processed.” Thomas Sowell, Basic Economics: A Citizen's Guide to the Economy 50 (Basic Books 2004). In the Soviet Union there were a handful of people controlling over 24 million prices for a country with a population of over 100 million people; so few people simply did not have enough time to manage that many prices. As a result, an imbalance between the production of goods and the demands of the consumer occurred.

The same effect is creating a distribution bottleneck in the film industry. Currently, distribution companies employ a hierarchical business model to determine which films get distribution. A distribution executive either “green lights” a film internally, or screens films which he either accepts or rejects based on his personal bias and opinions. Typically these highly paid decision makers try to employ a very intricate and thoughtful evaluation process based on their experience, comparative box office data, and their company's financial objectives. In addition to a film's individual merits the studio executive also considers which other films are scheduled to be released that may adversely affect the film's box office performance. Without a distribution deal an independent film will not be theatrically released.

The decrease in the cost of digital production and post-production equipment and the availability of online information and collaboration has resulted in a huge surplus of feature length films being produced on a global level. An independent study shows that over 30,000 feature films were submitted to film festivals in North America in 2006. And yet, according to the MPAA entertainment industry Market Statistics for 2007, only 603 films were released in theaters.

The first step after a film is acquired by the distributor is to estimate the number of screens it will be released on. The studio looks at what they think the films demographic appeal will be, as they try to determine which markets will best serve the film's profitability. They then decide how much they will spend advertising the film. They book their theaters by phone call or fax, and schedule the advertising campaign. Next they order digital or physical copies of the film for their theaters. Digital copies (the subject of the DCN system, below) are very inexpensive compared to 35 mm release prints, which cost anywhere from $1200 to $2000 each, depending on the film's length. The prints and advertising costs make up what is called the “Prints & Advertising (“P&A”) budget. Studio P&A costs usually range between 35% and 100% of the film's budget, and sometimes more. Because each film requires a significant upfront investment, distributors are very selective about the films they choose to support within their distributions budgets. A great majority of films are rejected very quickly. Out of the 900 films selected to be included in this past year's Cannes Film Festival, only 4 were acquired for distribution. When you consider the fact that approximately 4,500 films were submitted to the festival for consideration, it becomes apparent that there is a great deal of content not finding a distribution home. An independent study shows that over 30,000 feature films were submitted to film festivals in North America in 2006. IMDB.com (the website of the Internet Movie DataBase) contains a list of 600 Film Festivals worldwide.

Second, there is a great deal of unfulfilled demand in the film industry due to technical obstacles, inflexibility, and industry control over what gets shown. Under the current regime, studios and distributors are minimally responsive to consumer demand for particular content. Before and as the movie is being made or as it is selected, the predictive tactics discussed above lead to inefficiency and resulting loss of profit and consumer dissatisfaction. And once the film is already in the theater, studio and distributor interference with market forces compounds the problem.

Rent control as a method for allocating another of humanity's basic needs, housing, serves as an illustrative analogy. When rent control is imposed by an interfering legislative entity, usually a municipal or state government, it creates a housing shortage—not because there are not enough housing units, but because of the unnatural pricing control exerted on the housing. When rent control is imposed on a building, the rent remains static and does not naturally adjust to the dynamics of market fluctuation. Two situations simultaneously result. First, the cost of upkeep on existing buildings and the cost of development for new buildings far exceed the revenue derived from keeping the buildings occupied. As a result, existing buildings fall into disrepair and ultimately are abandoned, and no new development takes place. Second, the demand for accommodation in uncontrolled buildings drives the prices so high that renters simply cannot afford to compete for living space. The result is exorbitant prices per square foot and an increase in homelessness, a socioeconomically inefficient and unsatisfactory solution.

Similarly, when a film is theatrically released the opening weekend box office results and the weekday performance are measured in per screen averages. We know how many people showed up and paid money to see a film on each screen in each theater that scheduled its play date. Today most films play in theaters for only 2 weeks, the films that perform well may stay 4 weeks, or in a best case scenario they may play even longer. If the film performs extremely well and is “a hit”, the distributor expands the number of screens and the distributor increases the films P&A budget. Thus, the typical film receives one week of screening, and only one opportunity for adjustment based on the week's data. More popular films receive only one opportunity for schedule adjustment. In addition, instead of responding to market response, many distribution companies use bully tactics to force exhibitors into extended release windows for films regardless of the market response to these films.

The result is empty theaters, increased costs, and dissatisfied consumers. The cost of keeping theaters open ends up greatly exceeding the revenue derived from ticket sales. As a result of centrally controlled product selection and a rent control like method of dealing with exhibition houses, over 24,500 theaters are not serviced by the major distribution companies. A secondary result is then that the price of concessions, such as popcorn and soda, skyrockets as exhibitors do what they can to keep themselves in business. Additionally, more potential movie goers opt out when the content they want to see is not being shown in a theater and at a time that is convenience.

Finally, there is a corresponding surplus of content not being shown or seen. Distributors, much like Soviet central control economists and urban housing legislators, simply cannot accommodate the huge surplus of product and the high demand for quality product. The selection process, and the high cost of acquiring, promoting, and physically distributing the film have resulted in a huge surplus of available product. The process works some of the time, but most of the time it doesn't work at all, which is illustrated by the fact that less than 10% of distributed films recover their P&A budget from theatrical box office. Most films go deep into the DVD revenue cycle before a film investor begins to get their money back. The majority of film investors lose money. It often takes all the combined downstream revenue outlets, Cable/Satellite Broadcasting/Free and Pay TV, sound track releases, and foreign sales revenue returned to the Producer to pay off a film's budgeted investment cost.

It remains a question how, even with the illustration of this major bottleneck, over half the screens in North America—24,500 screens—are not being serviced by the major Studio distributors. The answer is simple. People still go to the movies. Even though there are potentially tens of thousands of films that may never be seen, and even though there are theaters screening major films to only handfuls of people in empty theaters, movie goers are going to the movies even in theaters that don't get the major studio releases. This illustrates one very powerful point: even given the massive surplus of product from disenfranchised film makers and the empty theaters run by the disenfranchised exhibitors, there is still enough demand from film goers to keep over half of the screens in North America in business without major Studio content.

Disclosed herein are methods for breaking this distribution bottleneck through disintermediation, via a model that services the three constituencies—content creators, content consumers, and content exhibitors/distributors—and provides immediate market information to each of these three constituencies. Disintermediation is a term that means “taking out the middleman.” The systems and methods disclosed herein remove the guesswork from the film selection process because, unlike current methods used by the studios, the methods disclosed herein work from the bottom up, not from the top down. Plainly put, since in the methods disclosed herein, films are selected by the people that want to see them, there is a far greater chance they will go see them. The methods are expected to result in high per screen averages compared with films put in theaters by distribution executives.

The systems and methods disclosed herein are based on opportunities created in the entertainment industry by the digital revolution, and in particular by the internet. An opportunity exists to change the way content is selected, promoted and shown in theaters, and in how advertising is targeted and delivered. The systems and methods disclosed herein are useful for increasing consumer satisfaction, increasing profitability and providing more stable profitability, increasing theater attendance, increasing advertising effectiveness/yield, and increasing efficiency of content production, marketing, and distribution. Additionally, methods disclosed herein will increase the probability that resources are directed toward films that will be profitable. Even further, methods are disclosed herein to generate large profits even if every film “flops”.

The systems and methods disclosed herein leverage the disruptive technology that is causing the chaos in the film industry. Instead of the linear supply and demand model, disclosed herein is a market based interaction between business entities in the film industry. The three interacting portions, or core constituents, of the market are content producers (film makers), exhibitors (venue operators), and consumers (movie goers). Simply put, the systems and methods disclosed herein will facilitate the delivery of one group's value to the other by disintermediation that is, removing the middle man as much as possible from the film selection process to facilitate a more “bottom up” flow of content value getting to the exhibitor and to the moviegoer. Members of an “Internet Community Network” (or ICN, estimated to attain 30,000,000 members or more) will personally select the content they admire and wish to patronize.

One of the three core constituents is the content creators—in a typical embodiment, film makers—who typically fall into one of two categories. The first group comprises those that have succeeded in getting their scripts and film budgets financed. The second comprises those who, armed with borrowed or purchased equipment, and an almost all volunteer staff, create their masterpieces with dreams of one day seeing their film on the big screen and becoming Hollywood's next big star. Every one of these people feel that what they have created is going to be enjoyed by millions of people. However, the majority of these artistically gifted, highly motivated entrepreneurs create products that do not merit theatrical release. In the systems and methods disclosed herein, the Content Review Group (CRG) will target those film maker members who do create good or even great films by asking the Internet Community Network (ICN) of movie-going members to rate each film's trailer, product reel, and/or film screener (the movie in its full form encoded against duplication). Via the CRG's internet database, it will enable participating exhibitors to make an educated decision when they book a vetted film they already know will have an audience.

As regards to a recent proliferation of feature films, a film maker's use of modern digital cameras has dramatically increased the number of films that have been made over the past five years, which has created a “bottleneck” wherein the number of film makers who can get their films made has increased, but exhibitors report that far too many of these films are not of commercial quality, and many don't have quality sufficient to deserve a theatrical level release. The CRG will have pre-selected a film, vetted it legally, and will help the film maker deliver a professional trailer(s), product reel(s), and screener.

There are a few film makers who have had the resourcefulness and drive to self distribute their own film, and they have had limited success in the theatrical release market. However, they will never be able to compete with the major studios. Whatever limited Prints and Advertising (“P&A”) budget the film maker has is usually spent on local news paper ads, if they can afford them. The vast majority of these films will never be seen by an audience in a theater, and most will never get any form of public exhibition. The systems and methods disclosed herein aim to change that situation. By leveraging internet technologies available as a result of the digital revolution, the systems and methods disclosed herein will level the playing field, allowing three constituents of the entertainment industry to interact in a market setting.

The next core constituency consists of the content consumers, or movie goers. All kinds of people go to movies and they come from all walks of life. But some movie goers go more often than others. According to the 2007 MPAA report, there were roughly 1,440,000,000 admissions to movies in 2007, and the industry took in approx. $9.52 billion dollars that year. Each admission represents the sale of a single ticket. Since the United States has an estimated population of over 300 million people, it's obvious some people go to the movies more than once, and some don't go at all. Tables 1 and 2 show which groups go to the movies and how often they go.

TABLE 1

| | Average Yearly |
|---|---|
| Group (by ethnicity) | Admissions per Person |
| Latinos | 9.2 |
| African Americans | 8.7 |
| Caucasians | 7.7 |
| Asian/Other | 6.5 |

TABLE 2

| | Average Yearly |
|---|---|
| Group (by Age) | Admissions per Person |
| 12-16 | 9.2 |
| 17-24 | 8.7 |
| 25-36 | 7.7 |
| 37-44 | 6.5 |
| 45-55 | 2 |
| 55-60 | 1 |

These movie goers choose from a wide variety of genres and MPAA ratings. In present markets G, PG, and PG 13 ratings account for approximately 75% of films selected for theatrical release. An “R” rating makes up the rest of a theater's schedule. Although the CRG will not put itself in the business of “picking hits,” since this runs counter to the bottom-up approach of putting users in control of selecting content, but will respond to the selections and preferences of internet based ICN members.

The final core constituent consists of the content exhibitors/distributors. In general, exhibitors fall into two categories, the “NATO” group and the independent exhibitor. The National Association of Theater Owners (NATO) is comprised of the larger chains and usually book “major studio” films, while the independents typically get few if any studio films. This independent group makes up approximately 50% of the exhibition market. When independents are lucky enough to get major studio films it is often after the film has played out in NATO theaters and the independent theater owner must compete with concurrent studio releases on DVD, Pay-Per-View, and hotels/airlines. These are called sub-run theaters. There are some exhibitors that get major studio films at the same time as the larger NATO theaters, but they do not get enough of these major films to sustain a steady stream of business. Therefore, they do not get the larger audiences and they typically struggle to stay in business. Because these Independent theaters cannot get enough current films, they are often forced to play old movies that do not interest consistent movie goers.

There are currently about 47,500 screens in North America. Approximately 22,000 or 46% are used systematically by the major studios. Many of these exhibitors cannot get the major studios to give them first run films and do not have quality films to attract their primary fans. This, and the fact that they have not focused on attracting new customers, forces these exhibitors to plead with the studios and other distributors for new first run films. In most cases they do not get enough new films for their businesses to flourish.

For the most part the major studios take the majority of the box office revenue when a new film is released and the exhibitioner makes money on concessions. In fact, concessions account for more than 50% of an exhibitor's profit. This is why popcorn costs $5 and a soda costs $4.

Exhibitors will have a distinct advantage when they book films to play in their theaters using the systems and methods disclosed herein. The CRG will have already forwarded the trailers and screeners prepared by the film maker to exhibitors. Data from the ICN will have prepared the exhibitor for the audience acceptance a vetted film might receive. The exhibitor will be ready to provide the right number of screens and the right distribution window for their films. In this way, film makers value theatrical distribution provided by the exhibitor network, movie goers value having a choice of what will be shown in theaters near them, provided by the film makers, and exhibitors will value movie goers whom the CRG will deliver along with our fresh new content.

By establishing and maintaining a Content Review Group and an Internet Community Network, the methods disclosed herein utilize disintermediation to provide film makers with the ability to put their finished product in front of exhibitors and movie goers to determine the most successful release for each film. Film makers benefit from an automated submission process for screeners and trailers, including legal forms and a deliverables checklist; demographic information from movie goers based on trailer response; and demographic information from exhibitors based on screener response. In addition to these benefits, the methods disclosed herein will also aid in the advertising of the title based on the popularity of the film.

There are two types of projection technologies in the Film Industry today: 35 mm projection and digital projection. Currently the majority of exhibitors are utilizing 35 mm projection, although there are an increasing number of theaters that are converting to digital projection. It is estimated that within 15 years, all motion picture theaters in North America will have to be converted to digital projection or they will not be in business. The film industry has proclaimed its intention to stop providing 35 mm release prints by that time.

The systems and methods disclosed herein are suitable for application not only via embodiments employing digital projection and/or electronic distribution, but also to more traditional methods utilizing 35 mm film, at least initially. In certain embodiments, film makers will finance their own 35 mm prints for shipment to interested 35 mm exhibitors, or a minimum number of 35 mm print orders from exhibitors will be confirmed prior to distribution.

The constraints of making and shipping 35 mm prints is more restrictive than the flexibility inherent in digital distribution; therefore, two different models may be employed to service both 35 mm and digital exhibitors.

The first is a “fixed week” exhibition for 35 mm theaters. The cost and time constraints involved in creating and shipping 35 mm prints to theaters makes a longer film run desirable in order to offset the costs and increase the potential for profit. In addition, a degree of flexibility is necessary for exhibitors to be able to respond to market fluctuations. In the fixed week model, exhibitors will commit to 35 mm screenings on a guaranteed one week basis. Fixed week exhibition mitigates the cost of 35 mm screenings by committing to a minimum timeframe for a run, and provides exhibitors with flexibility by allowing them to extend a run for popular films, and schedule new titles to replace poorly performing films.

The second is a flexible exhibition for digital theaters. Digital theaters have the capability of being connected to the Network Content Library via the Digital Cinema Network (DCN) (see below) Since digital content requires a reduced delivery time, and since via the DCN and the NCL a virtually unlimited number of first run quality digital copies can be distributed to exhibitors, a flexible exhibition business model is available for exploitation by the systems and methods disclosed herein, and participating exhibitors. A flexible exhibition model allows exhibitors the ability to respond immediately to fluctuations in the market without being restricted by the number of prints available. A major hit movie is only restricted by the number of digital screens available instead of by the backlog availability of 35 mm prints. With an increasing number of digital screens becoming available over the next 10 years, it is entirely possible that releases of films may increase into the tens of thousands of screens. The content available to digital theaters provides exhibitors with the ability to respond immediately to any market fluctuation. One-off screenings and limited runs will be economically feasible due to the ease of access to digital content. Participating exhibitors will also have access to very detailed demographic information about films in the content library due to the immediate response from participating movie goers, giving the exhibitor detailed information from which they can make educated choices of what films to exhibit in their theater.

Social networking has become ubiquitous in the world today; online websites like MySpace, Facebook, and Flickr each serve a slightly different version of the human need to communicate and share experiences, and each has been overwhelmingly successful. The public's acceptance of these new communication platforms has led to an explosion of available demographic and psychographic information to business owners and advertisers. The use of viral grass roots marketing due to social networking has exploded. A person cannot sign up for a web service without seeing a very familiar phrase—“Share this with a friend!”

Social networking is not a standalone business model. People don't just like to talk, they like to have something to talk about. The success of this phenomenon depends on depth of content and existing business processes. MySpace, Facebook, and Flickr each leveraged communication technologies on top of already existing content bases. MySpace initially provided a platform for the independent music scene in Los Angeles. Facebook leveraged existing relationships between school friends. Flickr started out as a geo-centric communication game and evolved into the largest database of photographs in history. Project Playlist was a service that evolved by using MySpace as a distribution tool to become an unauthorized tool that took off and gained 4,000,000 sign ups in the first 8 months. In 2008 Project Playlistbrought people together around music, and had over 40 million registered users garnering 11 million unique visitors each day.

The Internet Community Network provides a platform to involve film goers in the process of distribution. Film goers will find themselves involved in, for example, three levels of content that will be available in the Network Community Library (or content library): new movies, movies in theaters and classic content. Additionally, the library may be expanded to include other content such as episodes of television shows, music, live or recorded musical and theatrical performances, etc. The ICN platform is, in essence, a method of interacting with the NCL. To the Movie Goer, the NCL is an online catalog of content from which they can select content they want to see in their local theaters with the same ease they select television shows with a remote control.

When film makers submit their screeners and trailers to the Network Community Library, their screeners, product reels, and/or trailers (sample content) will also be made concurrently available to exhibitors. Exhibitors will be able to rate the screeners, product reels, and trailers, providing a professional opinion on the film that film makers, movie goers and other exhibitors will all be able to see. Movie goers will be able to respond directly to the exhibitor ratings which will answer one or more simple questions such as: Would you like to see this film in your local theater? and When would you like to see this film?

The systems and methods disclosed herein will also enable film makers to market their films within the ICN. This platform will allow film makers to participate directly in promoting their content to potential buyers, to film goers and beyond the ICN, in a grass roots fashion. This aspect of the system, available to filmmakers, will utilize Web 2.0, Web 3.0 and future technologies, applications and conventions to provide film makers the power to promote their own work. For example, a filmmaker who is already aware of a subgroup of consumers who might be interested in his or her product may utilize psychographic data to market directly to a receptive audience. Alternatively, the filmmaker may use data available through the ICN to help him or her identify a receptive audience. For a film maker, the ability to campaign for their film is much like a candidate that knocks on doors to get votes—yet it is more powerful, since it arms the filmmaker with the addresses” of those who already share common ground.

Exhibitors and movie goers will also have the ability to give feedback on films currently in theaters. Word of mouth is the most powerful form of marketing for film. When people see a great film, they call their friends and family and recommend it. In the methods disclosed herein, in addition to sharing information about films with their friends and family, ICN members will be able to rate, tag, and review films that are already in theaters. Additionally, theater attendance may be used as an indicator of a film's popularity, particularly if that popularity persists over multiple screenings.

Of the 603 Movie releases that the MPAA reported in 2007, 13 of these movies were re-issues. Exhibitors will engage re-issues of existing titles when the market demands it. Movie goers will have the same access to classic content in the Network Community Library as they do to movies in theaters. An increase in the popularity of a classic title among movie goers will be immediately available to exhibitors, precipitating a potential re-issue.

The methods and systems disclosed herein empower the movie goer and remove the distribution executive from the process of selecting the content that theaters play. It also empowers the exhibitor to select films based on the potential financial success of an exhibition, reducing the amount guesswork in their selection process. The Internet Community Network connects the exhibitor and movie goers directly in a way that allows the content to flow more freely to where and when it needs to go. The NCL will facilitate this transaction via the licensing models described herein. The film maker, the exhibitor and the movie goer will become clients to the systems and users of the methods disclosed herein, which will unite each of these three core constituents, leading to profits for the system owner, even if initial Internet Network Community ticket sales are at a bare minimum.

Shorter runs of a particular film may occur for Network Community Library films compared to studio films, which typically play for 4 or 5 weeks. For example, some films may play for no more than 2 weeks on any one screen. In certain embodiments, a film may be shown only once in a given area. If you've ever gone to the theater and been the only one there to see a film, you've experienced what happens when the studios insist that the exhibitor keep the film playing despite the fact that everyone in that area that values that film has seen it. The methods and systems disclosed herein leave this decision up to the exhibitor and the movie goers. If a film's per screen average drops off in a specific theater, it can be replaced with another film, selected by the exhibitor and/or the movie goers themselves.

When Network Community Library content is provided via the digital projectors provided by the methods disclosed herein, theater owners will have the ultimate flexibility in scheduling. In fact they can show one film during the week, for example a tear jerker for soap opera fans, and then show another film on that same screen in the evening that caters to wrestling fans. This is impossible with the current analog projectors and the constraints mandated by the studios.

However, if constituents see that a film is a “hit” and the “per screen average” is very high, the distributors/administrators as envisaged herein will be able to add screens very quickly and we can alert Internet Community Network members when a film's release pattern has been widened. In the same way, distribution will also assign more marketing support to “hit” in the form of more online and traditional advertising.

In certain embodiments, the systems and methods disclosed herein provide the major studios with films that need larger commercial marketing campaigns. In such cases the Internet Community Network will act as the farm system for the major studios, who will be able to see how much a Network film is valued before they spend their considerable resources.

The website portion of the system disclosed herein will have three interfaces, each one designed to satisfy the needs of our three core constituents; the film makers, the movie goers, and the exhibitors.

As a distribution company the distributor/system administrator will license any content that is allowed to enter the system. Optionally this licensing may occur only after certain levels of proprietary popularity are reached within the website community via a progressive licensing scheme described below.

The systems and methods disclosed herein differ significantly from those employed by web-based technology companies that have already entered the industry, and by movie studios. Each is in a sense a distributor of content, but this role is different as envisaged herein.

The success of web-based companies such as Netflix and Amazon.com can be directly associated with the same strategies that other web based companies have used, to decrease the inefficiencies and costly practices, inherent in most brick and mortar based companies. The source of their success has not come from introducing new products into the market, but rather by simply introducing more efficient ways to deliver existing products to the intended customer. When you evaluate their business strategy it is clear that they are focused on the 135 million US households that have invested billions of dollars in home theaters, lap tops, and handheld devices. This model reduces much of the cost associated with retail order taking. As a result of this shift in consumer behavior, the film industry's main aftermarket revenue source, DVD sales, has been going down year over year as the internet companies' customer bases have steadily increased. The systems and methods disclosed herein eliminate costly, generic promotion and advertising to the idealized consumer, and replace it with efficient, targeted advertising to a receptive individual consumer.

In a traditional motion picture distribution model, a critical revenue window is DVD/video rental. In a rental model, a film maker does not build a library; he or she only needs to license the rights to distribute films to distributors who in turn license rights to the rental outlets. The film maker or owner derives their revenue through licensing fees and royalties and does not maintain a large library of titles, but someone inevitably does.

The two major DVD/video rental players are, at present, Blockbuster and Netflix (with others such as redbox on the rise). Blockbuster maintains a chain of brick and mortar locations where customers browse through titles and pay a rental fee for temporary use of the media. Blockbuster has added a web service where customers subscribe to rent and buy titles that are delivered through the mail, as well as rent or buy downloaded titles for immediate viewing on the computer. Netflix is strictly a web platform, offering subscriptions for titles to be delivered through the mail, as well as instant downloads that can be viewed online. Both companies are now extending into the video on demand market through set top boxes that allow customers to view titles on their televisions.

The distributor is different from either Netflix or Blockbuster because it may be a content owner. The distributor will have direct access to its theatrical exhibition network as it guides film makers to the member exhibitors via the CRB and the ICN. The distributor may own a significant portion of a film maker's film rights. A theatrical release always drives the profit potential of the “after markets”, such DVD sales and rentals, and thus benefits all parties. An extensive film rights library is envisaged as a key component of the methods disclosed herein. This library of titles that can be licensed to world-wide markets, including companies such as Netflix and Blockbuster.

The distributor is also different from that of the major studios in several ways. First, it targets independent films as well as major releases, while the major studios are moving away from independent film. The studios have been routinely closing most of their studio controlled independent film production companies. Also the studios have concentrated on making more major releases such as big budget “tent pole” films, while the distributor in the method disclosed herein does not produce or finance the production costs of a film. At present, studios typically invest millions, and sometimes hundreds of millions, of dollars to promote a single tent pole film. The distributor will leverage its proprietary or participating social networking sites as the primary source of advertising, but may at its option also leverage the film's theatrical release with in-house P&A funds.

In short, the methods disclosed herein enable the creation of an online film market in which millions of movie goers share a level playing field, with exhibitors and distributors, instead of delegating content choice to the small cadre of major studio executives and distribution executives who attend the well known major markets such as Cannes and the American Film Market.

The Internet Community Network plan will be built in three phases. First will be the exhibitor Network which will attract film makers, which in turn will attract the movie goers. This will occur by building exhibitor relationships with already in place digital cinema theaters, and concurrently begin the digital conversion of theaters in the Network. Phase two will entail the building of the social networking community network based internet site. In phase three the content library will be built by licensing and acquiring films.

Exhibitors will be attracted through a combination of fresh content, new customers, and the digital upgrade of their business by leveraging the flexibility and consumer-responsiveness of the platform. As exhibitors sign up to the Internet Community Network, the website with its three interfaces for the three Choice core constituent groups will be built. While the exhibitor Network is being put together and the website is under development, system operators will begin attending film festivals such as Sundance, Berlin, Cannes, Toronto and the American Film Market in order to garner interest from content producers—filmmakers—and begin to identify content for the Network.

Several target markets may be accessed and served via the methods and systems disclosed herein.

As previously discussed, the major studios (Majors) have a very high overhead cost which limits what content they can bring to the theatrical market. In order to recoup their overhead, major studios must make films that appeal to a broad audience. Well made films that appeal to smaller demographics do not fit the major studio model strictly for economic reasons. For example, if a well made film would be valued by a certain group of movie goers the major studios will steer away from it because of their huge overhead cost. Their marketing departments are set up for broad appeal, mass market films. The gap that has been created by the Majors not wanting to service “niche” market films is a market which the is uniquely capable of servicing. However, the system is also expected to get people who already go to the movies to go more often.

The Motion Picture Association of America (“MPAA”) provides statistics that illustrate this opportunity very clearly. Some people go to the theater 8 times a year, while others go only 1, 2, or 3 times that year. The main reason these majority groups only value 1, 2, or 3 screenings of the major studio offerings per year is the selection of major studio projects—the content. The systems and methods disclosed herein will provide movie goers with more films played more frequently to audiences who have already expressed their desire to see a specific film. Therefore, movie goers patronage is expected to increase to 2, 4, or 6 times per year, with at least two of these new films being offerings from the Network Community Library (content library).

For example, the systems and methods disclosed herein are capable of engaging cultural and ethnic groups in a way that current major studio methods do not, and providing them with a mechanism to attend exhibitions of content that would previously have been unavailable to them via the major studio channels. India produces more feature film than the United States through “Bollywood”. These films are typically musically based and they are extremely popular around the world. The USA has a major Indian population spread all over the country, but like most ethnic groups, there are communities that have highest concentration of people from India, such as Los Angeles, New York, Chicago, Atlanta, Oregon, and Seattle. Again the major system is ill equipped to cater to specific groups for theatrical releases. While it is possible for the majors to service these markets, a major studio's huge overhead structure makes doing so unprofitable. Internet Community Network Members from India, or Indian-Americans in the United states or elsewhere, can request that Bollywood films play in the theaters that are in their communities, as can people from Mexico, Asia, Europe, etc., and concentrations of those cultural and ethnic groups in the United States.

In addition to the release of specific general audience films, people may have an affinity for a specific sport or activity such as skate boarding, wrestling, skiing, and many other interests, which the Internet Community Network website can identify and deliver films to these audiences that contain this “niche” subject matter.

Additionally, “art house films” are films with subject matter that is not overtly commercial. It is an all too rare exception that art house films get theatrical distribution. Internet Community Network members who value these more artistic films will be able to identify their favorites and select them for exhibition on the silver screen.

Additionally, many famous “A list” actors and other artists have made or want to make films that they value, “passion projects.” For example, while the actors' popularity may have come from major studio “tent pole” films, as artists they yearn to play roles that are a departure from the highly commercial action/thriller studio films created to cater to the masses. The Internet Community Network and associates systems and methods disclosed herein will be the outlet that allows more of these films to come to market. This will also provide the Network with unique, high caliber content that other distributors do not service or will covet as these films make their way into the Network Community Library.

In summary, there are several opportunities to utilize the systems and methods disclosed herein to meet the needs of large groups of people by harnessing the power of the movie goer using the internet selection platform disclosed herein. For example, using the systems and methods disclosed herein, a profit can be made on a film that only plays in a couple theaters or one that plays in 4,000 theaters. In certain embodiments, films will be released on less than 500 screens, but the number of films released each year will be much higher. These totals will add up to a highly profitable quantity. For example, if a single major studio film is released on 4,000 screens, the system and method disclosed herein can equal this screen release number by booking 8 films on 500 screens each.

Unnecessary expense may be cut on several levels, leading to more efficient and profitable operation for exhibitors, and correspondingly lower costs to movie goers. These benefits may in turn spur exhibitors to improve the movie going experience for consumers in the form of reduced refreshment prices, and improved and expanded facilities, for example, which may further inspire consumers to return to the theater more often. Areas in which the systems and methods disclosed herein may be expected to realize increased efficiency and higher profits are in distribution fees, theatrical box office revenues, DVD/television/video-on-demand, and foreign distribution.

Because advertising and overhead costs are just too high, most films do not achieve sufficient revenue performance at the box office to extract enough revenue to cover a film's marketing cost after distribution fees and the exhibitor's share are taken off the top. In general film makers do not get any positive revenue from the theatrical release. The film is usually well into its DVD and/or television cycle before enough revenue is made to recoup the investor and begin to benefit the filmmaker. Use of the systems and methods as disclosed herein, on the other hand, will enable realization of a profit where other distributors often do not. The distributor as disclosed herein, as a functionality of aspects of the systems and methods disclosed herein and a member or administrator of the Internet Community Network, will charge a distribution fee for all titles that it releases as do all other distributors. The fee will vary depending on where and how a film is released. The fee for a theatrical film release may be between 25% and 35% of gross revenue, while the fee for DVD release may be as high as 70%.

The distributor as disclosed herein may receive an average of 50% of the gross box office from ticket sales. This level of participation will be very attractive to exhibitors because the major studios often take 90% to 80% from the first two weekends, leaving the exhibitor with only 10% to 20% earnings from ticket sales. The exhibitor only gets a larger percentage of ticket sales if a major studio film stays in the theater for more than two weeks. However, oftentimes after the first two weeks most people that wanted to see the film have seen it.

Additionally, DVD, cable, satellite, network and pay television, video on demand, and ancillary products such as sound tracks, are very important to the profitability of a film. In fact the vast majority of films do not make a profit until these revenue streams accumulate. As previously discussed, the cost of distribution and P&A expense combined with exhibitor revenue sharing typically is not adequate to yield a return to the film maker. The major studios largely view a film's theatrical release as a necessary tool to promote the film so they can make a profit from its downstream revenues. Plainly put, these “downstream” revenue centers are where most of the money is made by the industry. In certain embodiments, these after markets may be served “in-house” in the form of direct offerings via the distributor as disclosed herein.

Additionally, the Network Community Library itself represents an opportunity for profit realization. On average 80% of a film's revenue are realized in the first five years of its release to worldwide markets according to industry sources. As films go through and complete their full revenue cycle, there is a great value in owning all or part of a film's copyright. The copyright value of a large library can be worth more than the individual performances of many of the films in the library. Recently, MGM sold its library to Sony for $3 billion dollars. A very large library may be built in a relatively short time through the acquisition of title sharing deals that are made with the copyright owners. All films that use the system disclosed herein, regardless of whether they are theatrically released, will be a part of the video archives that use the video on demand transaction model. Depending on how they are ranked in popularity, some films may get DVD, cable, satellite, network and pay television, video on demand releases, while others may only get a video on demand release.

Foreign sales account for about 60% of net sales revenue for any given film according to the MPAA. Further, American-made films are sold through foreign sales agents who market a film to foreign distributors all over the world. Approximately 70% of films shown in foreign countries come from America, but in recent years most foreign territories have required their exhibitors to give locally produced content an increasing share of theatrical screen time. This said, oftentimes foreign audiences have grown up on American made films and are attracted to the same movie stars and production quality that dominate the market in this country. In certain embodiments, the distributor will retain its own foreign sales agent and will use the power of the web to provide foreign distributors with on-demand data in all foreign markets to sell and promote Network Community Library films internationally.

Even piracy can be utilized as a tool to the legitimate industry's benefit when the systems and methods as disclosed herein are employed. File sharing is not new to the millennium generation. Sites like Napster pioneered peer to peer file sharing by being among the first to exploit the potential of Web 2.0 technology. While the company was ultimately brought down by the major studios, and rightfully so, the fact is Napster introduced millions of people around the world to peer to peer networking and file-sharing. While the film industry grapples with ways to reduce the financial impact of piracy on their bottom lines, the systems and methods disclosed herein will utilize piracy in a way that other distributors have not yet figured out, or have not wanted to surrender to.

Under the model presented herein, audiences will have no reason to steal Library content; instead, Digital Rights Modeling (DRM) can be implemented so money can be made on the sharing of Library content over the internet. Through the use of DRM, any copies of Library films that are sent from the purchasers' computer or digital device to a non-purchaser will automatically trigger embedded advertising that appears before and after the film. These advertisements will be tracked automatically by the system so that accurate accounting can be reported to the advertisers, who will pay the distributor/administrator for getting their message to potential customers.

Additionally, film makers represent a scalable source of revenue based on their products' popularity. On the Internet Community Network website, a film maker will see how the member community values their film. If a film does well, the member filmmaker will see their creation bubble up to higher and higher popularity levels until their film achieves theatrical release status. Movie makers whose films fall short of theatrical release will be offered DVD, cable, satellite, network and pay television, or at minimum a video on demand distribution, depending on how well their film is ranked and valued by the Internet Community Network. In order for a filmmaker to submit a film to the Internet Community Network, he or she may be required to pay a reasonable fee in order to offset some of the distributor's film vetting expense. This fee will also serve as a deterrent to those filmmakers who have little faith in their project. This fee structure may not be introduced in the early stages of the founding of the Internet Community Network, but instead may be implemented soon thereafter as the Library builds its title base.

Additionally, major studios themselves may want to reap the benefits of the system and methods disclosed herein through participation in the Internet Community Network or through an alternate arrangement with the distributors/administrators, such as marketing support, which will be made available to them for a fee, and/or onscreen credits. While initial distribution may primarily focus on independent film makers via a massive online community of known customers, once the model proves to be successful at increasing the per screen averages for a given film, major studios wanting to use this tool to vet their content offerings.

Additionally, as the online community is built, a significant increase in advertising revenues is expected. It is anticipated that the Internet Community Network may be built to somewhere between 40 to 50 million users within the first 18 months of operation. As the operation is identified and branded, with such a large customer data base advertising revenue will be generated from advertisers that want to leverage the site. In certain embodiments this revenue will be in the millions of dollars.

In summary, unlike the studios, or independent film makers as they currently operate, the systems and methods disclosed herein reduce or eliminate risk in recovering the costs of producing and financing films. Instead, more cost effective online ICN generated “word of mouth” advertising is relied upon, supplemented with limited traditional advertising, to consistently hit “singles” and “doubles,” as well as the occasional “home run,” which will be exploited through increased advertising. This financially conservative posture enabled by the online Internet Community Network, will become a tremendously powerful management information tool that will be leveraged for its true value.

In certain embodiments, a comprehensive marketing and sign up kit will be provided to targeted exhibitors and will contain a complete portrait of services. This ICN package will communicate the value of joining our member exhibitor community. Exhibitors who join the Network will be able to select from a large array of new films that have the blessing of the films' potential audience members. After the Exhibitors schedule a film, movie goers in their area who have chosen the film via an ICN interface, will be notified of the show dates and times, for example via email through the website, through text messaging, or through friends who want someone to see the film with them. Having first run films in their theaters will increase box office revenue for ICN exhibitors along with an increase in their exhibitors' concession sales. The ICN Network will provide exhibitors with a combination of content and a ready-made audience; and furthermore, the distributor/administrator will seek to upgrade an exhibitor's analog projector to Network-compatible digital technology.

The most ambitious and determined constituency, filmmakers, will be motivated to join the Network and submit content for vetting after the exhibitor Network is established. It is estimated that 1,500 screens in the network will be sufficient to attract virtually any filmmaker anywhere in the world. However, this number could be lower, to say, 1000 screens or possibly fewer (presently, a 500 screen release is very good release for an independently produced and distributed film). A combination of domestic and international film festivals combined with industry publications both online and print media will be employed to promote awareness of the network and its systems and methods within the industry. When film makers see that they actually get paid when their films make a profit, the Network will become the independent film industry's first option for world-wide distribution.

The filmmakers' interface is a very important part of the marketing strategy. This section of the website will not only be used for education but it will also be used to provide easy access to important documents and resources that filmmakers will need to demonstrate chain of title and other important business matters. Vetting the films will be the most laborious task connected with building the Library. First it must be ensured that the film's submitter is the rightful owner of the copyright, or has that entity's permission. The “end user licensing agreement” (EULA) may be employed to cover the most significant deal points, such as digital rights. Further, a complete licensing agreement acquisition contract will be made available to encumber the films that show early signs of success within the Internet Community Network (see “option bundle” below). To facilitate this process, popularity ratings will be used to determine which films should be acquired and how much should be spent on promoting the films theatrical release.

### Progressive Encumbrance

To enable this concept, a progressive licensing system or method may be used which balances the needs of the distributor, which must have rights to utilize content in order to make a profit so as to justify administrative and advertising expenditures, with the needs of the licensor (a filmmaker or studio, for example), to retain the ability to offer certain rights in their content to another entity if their distribution needs are not being met. Under the progressive licensing system/method, content would enter the system via a comprehensive licensing contract between the distributor and the licensor which would contain a “bundle” of licensing options, which would provide for certain benchmark performance “triggers” as the content is exposed on the distributor network. The distributor begins with an initial level of licensing—for example, the digital rights to the content, which may represent an initial time sensitive term of licensing. The content is then made available via the ICN, optionally promoted, and is viewed and rated by ICN members. As a content's popularity increases to a pre-determined level, additional rights attach, such as certain theatrical exhibition rights, or DVD/home-distribution media rights, commercial and free television rights, Video-On-Demand rights, and others, justifying additional distributor marketing support. However, in certain instances, the licensor may wish to retain certain rights, say, the theatrical release rights, which he may have sold or want to sell to another distributor. However, once the network has demonstrated a model for a theatrical level of popularity, as is indicated by network members, the ICN will have retained all distribution rights in our option bundle contract and the rights to that content encumbrance would be complete for the terms provided for in our agreements with the content providers.

For example, a filmmaker may have a movie; he may have shopped around but not found a distributor, or alternatively, he may have been identified and approached by the Content Review Group as disclosed herein, or a similar body. He may know or be educated as to how the film targeting and distribution system disclosed herein operates. Both parties, filmmaker and distributor, want the movie to get to a theatrical release. But the filmmaker may be unwilling to turn over all rights at the outset, without proof that the film will receive adequate marketing and distribution. Traditionally, a filmmaker would presumably hope to have his film licensed by a distributor, who would ideally advertise and distribute the film widely in the traditional way. Although such deals are rare, a filmmaker may be unwilling to sell or license rights in his film to a smaller, less capable, and/or less proven distributor as a package, out of concern that to do so would dissuade a later-coming, larger distributor. The progressive licensing or progressive encumbrance system disclosed herein benefits both licensor/content provider/filmmaker and licensee/distributor/administrator by allowing the system to function more fluidly and with the acquisition of far more content, because protracted, lengthy and expensive contract negotiations will have been replaced by the initial “option bundle contract” which has already established agreed upon benchmarks for triggering additional, and/or an increasing number of content rights acquisition. If these benchmarks are not met, a specific level of rights is/or are released, and the content licensor may take his content elsewhere for distribution. This method eliminates lengthy on-going and potentially conflicting negotiations between the distributor and the licensor as the distributor successfully exposes the content to our world-wide ICN members. At this time, our ICN distributor will decide what the content's advertising and promotion budget will be, and will finance that expense for the content provider, under the terms and conditions agreed upon in the progressive licensing system.

Based on reactions or member content consumers, promotional material, a film (or other content) may establish itself in the Network, and gain popularity. As a result, a member exhibitor may select it for exhibition in its theater. This selection represents a heretofore untapped method of quantifying a film's actual popularity, in contrast to the unreliable predictions of test audiences, exit polls of theatergoers, and “hits” on internet engines, commonly in use today. As popularity, measured by the number of theaters selecting the content, increases, the system or method applies progressive encumbrance to automatically grant more rights to the system or method owner/operators. This model is similar to that typically dictated by film distribution company, except that given the fluidity and responsiveness of the system and method, the “windowing” system used with films (first, theaters; then to DVD, and finally, perhaps, to TV) is deconstructed. Instead of being dictated by the distributor, the window is driven by popularity. Additionally, as demand for a film or other content declines, it may leave the theater, only to return at a later time. Additionally, a stage may be reached where the consumer may purchase access to a single digital download that can be played anywhere.

One of the benefits of the website and the attending Internet Community Network is transparency. After a film's acquisition has been completed, its popularity rating will be illustrated to the community of film makers and movie goers which will allow that film to continue building a following. Films that achieve the highest levels of popularity will get more traditional and online promotion than less popular films.

Another benefit is in efficiency. As a direct result of automating most of the legal vetting process, efficiency in cost and time will streamline certain delivery items involved with the film acquisition process, saving money for everyone, there being no need to create delivery items for a market that does not exist. In fact, with the benefit of the metadata the ICN collects, delivery times can be specialized and “made to order”, as content finds its audience. Costs are often very high because of a lack of standardization. Today, each time an acquisition takes place, both sides have attorneys who haggle over every deal point. A key objective will be to dramatically reduce the cost associated with this part of the process by incorporating as much as possible in the End Users Licensing Agreement (EULA).

Through viral marketing, Internet Community Network members will be a virtual army, helping to get the word out to movie goers. Once the Library has increased to acceptable levels, traditional mass marketing campaigns will be undertaken to bring people to its appropriate market site. Extensive web-based marketing will be deployed on sites like MySpace, Facebook, Flickr and Project Playlist to bring online social networking fans to the Internet Community Network site.

Pricing packages will be offered to attract different audience/consumer groups. In certain embodiments, a premium subscription package for members will be offered, in which, for a recurring membership fee, these members will receive additional value added services, such as: unlimited downloads and theater tickets. Members may also save money and time waiting in line by purchasing tickets online. In certain embodiments, they may also get the video download for free with their purchase. In certain embodiments, advanced sales customers may simply provide their Membership card to the ticket agent when they arrive at the theater, similar to a Starbucks card. Other specials will be added to drive advance purchasing. Walk in business represents the majority of ticket sales at theaters. In certain embodiments, the difficulties of walk in business will be eased by promoting a mobile ticketing platform that allows people to purchase movie tickets on their mobile devices.

### Targeted Advertising and the Dynamic Brand Landscape

The world has changed enormously, and so have the advertising methods companies must use to engage potential customers. Gone are the days when the entire family would convene around the single family radio or television set to watch the Dick van Dyke show together. Advertising strategies that depended on communicating the same message to very large numbers of people have yielded to more targeted approaches dictated by the scattering of viewer attention as a direct result of the internet and digital devices such as video games, iPhones, and laptops. As America has become a melting pot of people of many races and cultures, the need to get their attention has never been more onerous. Advertisers pay large amounts of money to companies that can prove their ability to reach viewers if they are quantified and aggregated into demographic groups.

As noted above traditional advertising of films is a very costly, therefore it greatly contributes to the distribution bottleneck. The system and methods disclosed herein will flip the spending on advertising of films in favor of online and viral marketing, which will substantially reduce the distributor's financial exposure. While there will be minimum budgets for traditional advertising campaigns such as local newspaper ads, and posters, the majority of film advertising will be done online and via online-linked media. A replenishing marketing fund to support more costly films with extended advertising will be established and maintained by the profits of prior releases of content. More popular content will receive more advertising support than less popular content—the popularity of a film or other content with consumers themselves is the initial event that drives marketing, not the other way around.

Also provided herein is the first model for providing “off-line” advertising from online sources. The method of in-house advertising in theaters and other venues is cumbersome and out-dated. The explosive growth of online advertising has dwarfed the efficacy of offline advertising. The focus on online advertising has caused several lucrative offline advertising sources to be ignored. A novel advertising model is provided which has three main components: submission, assignment and delivery.

In one aspect, the advertising model provides for online submission of advertising content by regional, national and international advertisers. These entities may also be represented by advertising agencies. These entities are hereafter referred to as “advertiser.” Advertisers may use the same submission interface. Submitted campaigns may be vetted for inappropriate or offensive content. The submission component includes a management interface that provides statistical data for the advertiser to track and manage their advertising campaign.

The management interface is called the “Campaign Manager.” In one embodiment, the Campaign Manager provides the advertiser with four levels of viewing advertising campaigns: regional, national, international and niche/microtargeted. A niche/microtargeted advertising campaign is an advertising campaign that targets a narrowly defined population or group. A regional advertising campaign is one that is set to initiate within a specific geographical area. A national advertising campaign is one that is set to initiate within specific political boundaries. An international advertising campaign is one that is set to initiate with no boundaries. The management interface also allows an advertiser to stipulate a budget for each campaign.

The assignment component (Brand Intelligence Engine) of the novel advertising model provides a data-driven multi-level campaign option for advertisers. In one embodiment, the Campaign Manager implements a multi-level advertising strategy. It begins with a wide scale test market as defined in the previous section. Data is collected from online response to the advertising campaign. Data comes from three main sources, but is not limited to these three sources: customer psychographic profiles, regional data, and platform data. The Campaign Manager refines the advertising campaign to maximize the return to the advertiser by providing highly refined statistical profiles for the campaign.

Potential “offline” advertising platforms that are serviced by the novel advertising model disclosed herein include but are not limited to movie theaters, concerts, and public events; digital billboards; mobile phone screens; and within virtual reality constructs (such as, “Second Life”) and massively multiplayer online games (such as “World of Warcraft”). The Brand Intelligence Engine utilizes microtargeted advertising campaigns driven by customer psychographic profiles and ticket sales. Online ticket sales provides a specific “event profile” based on the combined psychographic profiles of the event's attendees. For instance, in the case of movie screenings, the event profile could change for every screening. Based on the “Event Profile” a microtargeted advertising packet will be delivered to the event exhibitor just prior to the event. For example, the targeted advertising may be specific to an ethnic or cultural group identified via customer psychographic profiles. For example, merchants of video games and comic books might wish to advertise to an audience of an anime movie. The microtargeted Event Profile also allows for customer appreciation clips, such as birthdays, anniversaries or wedding proposals, to be included in the advertising packets.

Because, as discussed below, the digital projectors may be an integral part of the system and method itself, the novel advertising model disclosed herein may be implemented in theaters on the same digital projectors used to present films or other content presented at a screening. The targeted advertising would take the place of the generic advertising reels or “slideshows” typically presented before a movie begins. Currently, these are typically projected on a separate projector due to the difficulty of splicing in advertisements to a film reel.

By way of example, a microtargeted advertisement might operate as follows. A member purchases tickets to a movie showing in their area—either online or at the venue. It is that member's birthday. The record of the ticket purchase is communicated to the ICN and/or a digital cinema network (DCN, described below). The member has purchased tickets to a Bollywood movie, and member's psychographic profile indicates that this person has done so before in the past. Additionally, the member's psychographic profile may indicate that this person likes Indian food, music, or culture. The DCN system then targets a birthday greeting to the theater where the member has bought tickets, perhaps to a Bollywood-style tune, and additionally, may run an advertisement for a local Indian food restaurant in the area, suggesting that the member visit there after the show. Such a system would not only represent a highly effective way of marketing to a specific individual, it would also recognize that person as an individual, as well as generate excitement and a sense of community amongst movie goers in the theater.

Each person place, location, object, or segment of time represents a “brand continuum,” in that each represents a distinct collection of attributes which people may typecast, or associate with a producer, here called a “brand.” Any brand continuum can be real or fictional—for example, the actor Meryl Streep as herself or as the character she portrays in the film The Devil Wears Prada, or for example Los Angeles in reality versus the futuristic and dystopian Los Angeles depicted in the film Blade Runner. Each of these brand continua are discrete and carry different brand information, and branding decisions made for each. The information about any brand continuum is collected and maintained as a set of weighted metadata. Weighted metadata describes a method of assigning a value to a particular category of metadata based on the repetition of the behavior that generates that metadata. For instance, if a consumer repeatedly purchases “blue” products, “blue” would be a heavily weighted category of metadata.

There are four classifications of brand continua described herein: consumers/individuals, regions/locations, content/media and brands/products.

A consumer/individual brand continuum is defined as the metadata that describes a person's quantifiable economic decisions. This information differs from a consumer's psychographic profile in that it is dynamic—the information contained in the metadata grows based on a person's interactions with other brand continua. The metadata of a consumer's brand continuum may be determined in a number of different ways. First, information may be collected regarding members' purchases, either with their consent or where permissible. This can be accomplished in several ways. First, the purchases made with a single credit card or payment form may be tracked; however, at present, this information is for good reasons closely guarded by consumers and their financial institutions. Alternatively, purchases from a single computer IP address may be tracked; however, this may be masked or changed easily. Another alternative is to track purchases via a suitably-enabled mobile phone, i.e., a smartphone. An identifier unique to each phone can be assigned based on the phone's serial number and the mobile phone number it is assigned. In yet another alternative, a ticket purchaser's browsing history, if accessible, may yield additional metadata building a brand continuum.

A region/location brand continuum is defined as the metadata that is collected regarding the economic decisions associated with a particular geographic location, such as a retail outlet or a movie theater. For instance, if the proprietor of a movie theater repeatedly purchases a brand of candy, such as Reese's Pieces, the metadata associated with that region/location would include a heavily weighted data subset for Reese's Pieces.

A content/media brand continuum is defined as the metadata that describes a particular piece of content. Content/media is unique because in addition to its own unique metadata it is a collection of other brand continua, including, but not limited to real and fictional individuals, real and fictional regions/locations and other content/media.

A brand/product brand continuum metadata contains information regarding the brand itself, but also collects information about its interactions with other brand continua, such as consumers/individuals, regions/locations and content/media continua.

Another option for determining an individual brand continuum which is becoming increasingly common involves the use of “tags” such as RFID chips, or other identifying structures, embedded by the manufacturer in portable goods such as electronics, shoes, and clothing that may be detected by capable electronic sensors. For example, a manufacturer of athletic shoes may embed a chip in every pair of shoes it sells, and place or contract for the placement of sensors in places such as shopping malls, gyms, sports venues and stadiums, and sports-themed restaurants. As the wearer passes one of these sensors, it transmits information to a receiver or computer, either on-site or remote. This information may contain the identity of the product, the purchase date, the identity of the wearer or demographic or psychographic data associated with the wearer. As this practice increases, an individual's brand continuum may become increasingly granular. When a sensor detects multiple chips as the wearer passes, it takes a snapshot of that wearer's brand continuum.

Where brand continua overlap in time and/or space, you have collections of brands. For example, an ordinary theatergoer may have driven to the theater in an Audi, and arrive wearing and Armani shirt, Diesel shoes, and a New York Yankees baseball cap, and carrying an iPhone, which when it accidentally goes off during the film plays a Jimi Hendrix ringtone which he had purchased. These attributes make up, in part, this person's brand continuum. Each theatergoer similarly will carry his or her brand continuum into the theater; each character in a film will have a brand continuum as well. When the brand continua of multiple theatergoers are considered as a unit, this collection may be called a brand landscape. The brand landscape may also include, for example, the location of the theater itself, the time of year, week, or day, the characters and setting of the film being shown, and so on. Statistical analysis of a collection of 6 people may reveal that the brand continuum of three of them includes Gucci, one Levi Strauss, and two Prada; this information assigns a “brand weight” to collective based on the brands chosen. When all these people are in a theater together, advertising can be targeted to the brand weights represented in theater. Because this collection change based on how full the theater is, the theater at any point in time represents a “dynamic brand landscape.” Not only each film, but each film in each location and in fact each screening may have a different landscape. Carrying the idea even further, GPS information on a smartphone (accurate to within 3 meters) or information from cell phone tower triangulation can even place a person in the theater or the lobby. If all the people whose brand continua contain Prada people go to the bathroom at the same time, the Prada brand weight goes down, and advertising can be targeted accordingly.

This concept of targeting advertising in accordance with a dynamic brand landscape is applicable not only in theaters, but online and in other contexts and locales as well. For example, in the example above discussing embedded sensors, if multiple people are detected by the sensor at once, a brand landscape is generated. Similarly, if multiple people with smartphones are located together in a restaurant, and a dynamic brand landscape is generated. In another example, if multiple people log into a virtual environment or massively multiplayer online game, and “meet” or otherwise collocate in that space, a dynamic brand landscape is generated. In fact, a dynamic brand landscape exists even when there is only one individual present.

Each of these situations represents an opportunity to target advertising or content in which the individual or group has an interest, thereby gaining the attention of the individual or group. In a shopping mall, a shopper or shoppers may pass a display screen linked to the system; information may be relayed to the system regarding the user's identity and the products being carried or worn. A display linked to the system can target advertising to the shoppers based in the dynamic brand landscape. For example, it may suggest to a shopper with shoes bought some time ago that a shoe sale is going on at one of the stores nearby, perhaps of a particular brand or style associated with that shopper's brand continuum or psychographic data. Or it may target a group of shoppers whose dynamic brand landscape has a large brand weight for Versace, and inform them via targeted advertising on a nearby display or speaker system that the spring line of Versace dresses has just arrived. The advertised content may be another brand as well that the shopper may like. In another aspect, the presence of a child on a dynamic brand landscape may alter the advertisements shown, for example to filter content or style of advertising to an age-appropriate level so as not to prompt a negative response from parents.

In a theater scenario, the dynamic brand landscape and possibilities are even richer. In addition to the brand continua of the patrons, the brand continua of the characters come into play as well. For example, the movie being shown may be a James Bond film, starring Pierce Brosnan. James Bond as a character has certain qualities which may persist across movies and actors who portray him—well-tailored suits and luxurious accessories, fast cars, and cutting-edge technology are constant themes. In the particular Bond film being shown, Bond may sport a Rolex watch and drive a high-end BMW. Even further, the film has a brand continuum independent of the characters, including, for example, the theme music and featured songs in the film, often by popular recording artists, and their associates genres. This creates multiple brand continua for the film and the character, which will create a dynamic brand landscape with the members of the audience who are fans of action films, James Bond films, cars or BMWs in particular, or Rolex watches—all metadata. Advertising or other content can then be targeted to this group. In a related embodiment, a “movie night” hosted at a member's home could create a similar dynamic brand landscape.

In a theater setting, an opportunity exists not only in the lobby and before the film, but even during the film itself. If the digital projectors showing the film are part of the digital cinema network, the film is a content file that may be altered before or even during delivery. For example, wallpaper bearing a subtle repeating pattern of the BMW logo may be superimposed upon or composited into a scene, and shown in the theater to an audience rich in fans of BMWs. A designer label may be placed on a character's shirt, or an item on the menu at a restaurant where the characters sit, or a product on the shelves of a store where the characters are shopping. This transparent “brand integration” in the film may be straightforward or subtle, and the latter would be exceptionally useful in regions such as the European Union where blatant advertising in a film is prohibited.

The basic idea of brand integration is not new, and it is quite effective. For example, in a James Bond film shown in the EU, the BMW logo was removed from cars in the film per regulation, but worked into the wallpaper in certain scenes. A 15% increase in BMW website hits was noted afterward. In the model currently in use, brand developers typically get involved during the making of the film and design advertising in this manner. What is unprecedented is the opportunity to change branding after the film is complete. Such “dynamic brand integration” could change from location to location or even showing to showing. Since the content is vetted and uploaded by system operators into the system, and is owned by the system owners, the opportunity exists to subtly target advertising for the entire length of a feature film—typically 120 minutes. Additionally, in the system and model disclosed herein, advertising goes back to the internet and the ICN as well. In addition to advertising before and after a screening, advertisers may incorporate their ads into or associate them with still images, behind-the-scenes footage, actor interviews, sash-ups of video content, and other “extras.” The extras may be sponsored by the advertiser or the promotional material may be worked in more directly.

The advertising model presented herein could permit a shift in pricing models as well. Traditionally, advertisers get involved in content production early and pay by the amount of time, typically in seconds, of on-screen time for their product. Prominence of display is of course a factor as well: a character may go so far as to take note of the product in the film by brand. In the system and method disclosed herein, a member advertiser would have access to online project management tools for media which integrates a marketing plan and branding structure. As film builds in popularity, original advertisers have the ability to grow their campaign by buying into a higher pricing structure, or new advertisers may buy in. The dynamic branding capabilities enable a dynamic pricing structure based on per-person views, instead of number of seconds spent onscreen. Additionally, an advertiser may purchase access to online advertising via the “extras.”

Advertising can also be refined over the course of content screening life as well. Although advertisers will not necessarily choose where their ads will be displayed, since this will be based in large part if not entirely on consumer data, the system and method disclosed herein utilized associational metadata in the dynamic brand landscape to refine the targeting of advertising. Demographic and psychographic data can be pulled up on a per-showing or per-theater basis of the audience which bought tickets. Each promotional clip thus has metadata which can grow. For example, Apple might designs an advertisement with the expectation that it will appeal to 15-25-year-old females, but find as they track the ad's performance that the people who responded to ad the most strongly were 25-40-year-old males. Using this information, the system enables the clips from other films featuring Apple products which cross promotes films as well as other advertisers. This reverses the advertising process. The overlap of the psychographic data of a brand and a customer—where they overlap determines what is shown.

In sum, the system utilizes a method of decoupling branding and advertising from content production and recombining it in meaningful ways for consumers and groups of consumers. The system provides an ever-growing database an interface of customer psychographic data, demographic data, etc., as well as interfaces with other databases of metadata, which result in a huge amount of data about a moviegoer before that person ever enters the theater. This data can change throughout the course of a single screening or over the sales life of the content.

### The Digital Cinema Network (DCN) Model

Bringing entertainment to the billions of consumers and prosumers around the world requires the same understanding and expertise as any other industry: products, consumers, supply and demand. As with all industry, it all starts with supply—the creation of a product or service that fills a market need. In the entertainment industry the product is simply content. In film, the content is film of all sorts: feature films, short films and documentaries are the main categories of films. There are subsets of each of these that are tied to the distribution vector identified for the market. For instance, made-for-T.V. movies are content that has been created specifically for broadcast television audiences. The supply chain for content is tied to three manufacturing steps: pre-production, production and post-production. The finished product is the content.

The main producers of content are production companies. Production companies create the content for consumption. For the purposes of this overview, consumption is referred to as exhibition.

The demand chain for delivering content for consumption in the specific markets is achieved through creating the prints of the finished content in the specific format for each type of exhibition.

In traditional supply and demand models, distribution is considered part of the demand chain. However, for the purposes of this document, distribution is being treated as a unique element linking the supply chain with the demand chain. In the entertainment industry the distribution companies have vast content libraries of copyrighted content. Each of the major and mini major studios has a content library. In addition to their own libraries, distribution companies will also license the rights to exploit content from other distributors and content owners. It is the responsibility of the distribution company to repurpose the content master in the media of the exhibition window which it chooses to exploit the content. For instance, for a title that a distributor wishes to exploit through theatrical release, the distribution company will make a number of prints for release and offer it to theatrical exhibitors for exhibition on theatrical screens. Distribution companies are also responsible for the advertising of the titles that they are exploiting.

The systems and methods disclosed herein eliminate a bottleneck in the supply and demand chain allowing for increased flow of product. The digitization of the workflow has led to cheaper, easier to use production equipment and reduced post-production time and expense. The final product is no longer a master film reel; it is a digital file.

The majority of theater screens in the country project their films on 35 mm projectors. Out of the 47,000 theater screens in North America, only 4900 of them have been converted to digital projection. In order to take a finished film to a theater, a 35 mm print needs to be made from our current post production standard, the digital master. Due to the relatively high expense of creating 35 mm prints from a digital master, only a limited number of prints are made. As a result of the limited number of film prints that are made, they are rigidly controlled. This results in nearly half of the 47,000 screens being unable to book movies in their theaters on a regular basis.

The systems and methods disclosed herein effectively pave the road between the distributor and the exhibitor by converting as many theaters to digital projection as possible and eliminate the distribution bottleneck. A nominal per screening usage fee to the is charged exhibitor, and a nominal per admission fee to the distributor.

In early October, 2008, Digital Cinema Implementation Partners (DCIP) announced that they had secured contracts with 5 of the 7 major studios for a “Virtual Print Fee.” DCIP planned to leverage these contracts with JP Morgan and GE Capital Partners to establish financing of $1.4 billion USD for the conversion of 10,000 screens to digital projection. There were two major flaws in this strategy: First, the strategy based its revenue on a variable revenue model. A Virtual Print Fee model derives income from the number of films shown on a screen in a given year. Statistics show that one film screen can show between 15 and 125 films in a year. This implies a huge variance in revenue per screen. Second, variable revenue increases the risk of the venture. The strategy implemented a $1.4 billion USD debt strategy. Incurring $1.4 billion USD in debt during the current period of economic flux introduces a high risk to the financing of the venture. The two entities that were interested in establishing the debt are now under federal oversight. It was announced at the beginning of November that there would be a delay in financing for the proposed DCIP deal.

Presented herein is a different strategy which will generate a consistent, renewable revenue model. Although there is an 82% fluctuation in the number of films that can be shown on a screen per year, the number of times all films are screened is constant. By implementing a nominal “per usage” fee to the Exhibitor for digital projection, the systems and methods disclosed herein creates a consistent baseline revenue flow. This revenue flow is then augmented by a per admission fee that is charged to the distributor for each film they show in the theater.

By re-investing 60% of all the baseline revenue provided by the usage fee, the Digital Cinema Network (DCN) is able to reduce the amount of investor commitment to $250 million USD for the conversion of 20,000 theaters over 7 years. This means we have the ability to convert twice as many screens for less than 20% of the investment. Reducing the amount of investor commitment allows Choice DCN to offer investors a competitive IRR in addition to an early exit strategy.

The benefits of the systems and methods disclosed herein are manifold. First, exhibitors gain faster access to the quality content they need. Theater owners that only have the ability to project 35 mm films are subject to a long process. Because of the high cost of striking a 35 mm print, content providers will only create the number of prints that can be justified by market demand. As a result, it is often the case that a limited number of prints will be made, and therefore the number of screenings per film. In addition, the quality of the print degrades due to operations—the film degrades over time. With Digital Projection, the number of screens that can show a film is virtually unlimited; and each screening has the same quality as a first run movie. In addition, since the mechanism for delivery is digital—as simple as downloading the film over a wide band connection, theater owners can get content faster than they could by ordering a print. This allows them to respond quickly to their customer needs.

Second, combining ease of ordering, content availability and faster market response time facilitates flexible scheduling. Since theater owners can respond more quickly to their customer base, if a film is performing badly, the theater owner no longer has to hold an empty theater. They can now book another film and continue to offer their customers fresh content.

By providing the infrastructure that enables theater owners to respond quickly to their customer base, and providing content providers with the infrastructure to supply their content to the theater owners, theater owners will have the opportunity to attract more customers to their theaters thus increasing their concession sales. Concession sales are the theater owner's life blood accounting for nearly half of their total revenue.

Additionally, the methods and systems disclosed herein will facilitate the content provider's ability to get their content to the theaters. Many types of content providers will be engaged to endure diversity of content; these providers include movie studios, independent distributors and production companies, and content creators themselves. As discussed above, revenue will be generated from content providers through a per admission usage fee for content that comes from their libraries.

The seven major studios drive high budget films and large scale attendance. “first run” films are booked by the major theater chains, and “second run” films are made available to the independents. The major studios largely self-finance their films and arrange to pay all the marketing and P&A costs through their own distribution subsidiaries.

Independent distributors and production companies account for 70% of the industry's content. They usually release on fewer screens than the studios depending on a film's genre, director, and talent. Independent films typically finance their productions through major studio production advances, and/or through a patchwork of funding methods (tax credits, debt, presales and equity). And yet, they are always subject to the whims of the major and mini-major distributors for their distribution pipelines. The Network will provide an alternative opportunity for the independents to distribute their films outside the major studio blocks of NATO Theaters. In certain embodiments, the Internet Community Exhibitor Network will have approximately 6,000 digital screens available within a period of no more than 30 months from the execution of this plan. In certain embodiments, 200 screens per month will be installed for the first six months.

The digital cinema network disclosed herein directly service two markets: exhibitors and distribution companies. The DCN in its most basic state is a network of machines. Each market has specific needs which benefit from the DCN.

Exhibitors need content. By keeping content playing on their screens, Exhibitors satisfy their primary market: the movie goers. Specialized services will be provided to exhibitors, including conversion to digital cinema projection and facilitated access to distribution companies and other sources of content. Conversion to digital cinema projection is important because the strategy for relieving the bottleneck between the incredible volume of content and the incredible demand of the exhibitors is in phasing out 35 mm projection in theaters. Exhibitors will go out of business without content. Access to Distribution Companies will be facilitated through a an optionally branded DCN Application Programming Interface (API.)

Distributors need to make their content libraries accessible to exhibitors. The digital cinema network opens up a whole new market of exhibitors to the distributors. The DCN will employ an aggressive sales campaign to enlist distribution companies and exhibitors to utilize the DCN. With the reduced overhead for digital distribution, increasing access will be provided to an underserved market of exhibitors. The DCN API will be provided as an additional valuable service to distribution companies. The API will provide distributors with the ability to expose their content libraries directly to the exhibitors via the DCN. The API also provides a branding opportunity for DCN.

At present, if an exhibitor were to convert a screen from 35 mm projection to digital projection, they would need to purchase digital cinema packages at a retail rate, incurring higher cost for individual unit prices and committing to the recurring costs of maintenance and upkeep on the equipment. The DCN as disclosed herein will leverage existing and developing relationships with equipment suppliers who provide the equipment necessary for the conversion of theaters to digital projection, and who provide maintenance service for said equipment. By negotiating bulk purchasing deals with equipment suppliers, the DCN will be in a position to negotiate lower per unit equipment and maintenance prices.

The delivery of digital content requires a solid technological “superhighway” to transmit the digital files from the distributor to the exhibitor. The DCN will develop relationships with national, international and local service providers, providing exhibitors with a reliable connection to digital content providers.

The DCN will establish a steady, predictable monthly revenue in the form of a per-screening Usage Fee charged to the exhibitor. An illustrative example is given below in Table 3.

TABLE 3

| Screenings per | Screenings per | Per Screening | Annual Revenue |
|---|---|---|---|
| Day per Screen | Year per Screen | Usage Fee | per Screen |
| 5 | 1825 | $15.00 | $27,375.00 |

Current industry projections are based on a “virtual print fee” that is charged on a per film basis.

The DCN is a content neutral entity, whose network is built to facilitate the delivery of content from multiple sources including both major studios and independent libraries alike. In anticipation of content from the major studios and their existing relationships, a virtual print fee engagement may be employed in order to respect their existing contracts. The virtual print fee will be shared revenue between the Exhibitors and the DCN.

From the foregoing description, one skilled in the art can easily ascertain the essential characteristics of this invention, and without departing from the spirit and scope thereof, can make various changes and modifications of the invention to adapt it to various usages and conditions.

What is claimed is:

1. A method of content distribution, comprising the following steps in any order:
i. providing an internet community network to a group of consumers having internet access, wherein each consumer becomes a member of the network by establishing a profile on the network;
ii. providing to the internet community network a library of sample content;
iii. providing the ability for members to perceive sample content and indicate favored content; and
iv. based on profile data associated with a plurality of members, together with these members' indicated favored sample content, providing full-length content to an exhibitor in such a way as to make favored content available to consumers.

2. The method as recited in claim 1 wherein the internet community network is provided to a group of consumers via a web site.

3. The method as recited in claim 1 wherein the profile on the internet community network is established by creating a unique identification in the network, then either
i. inputting user-associated data; or
ii. importing user-associated data from an external source available through the internet.

4. The method as recited in claim 3 wherein the data is imported from a social networking site.

5. The method as recited in claim 1 wherein the favored content is indicated by one or more of:
i. a member's rating of the sample content;
ii. a member's request for exhibition of the content;
iii. a member's forwarding of the sample content to one or more other users;
iv. a member's repeat playing of the sample content; and
v. an exhibition venue's exhibition of the content.

6. The method as recited in claim 1 wherein the content consists substantially of films.

7. The method as recited in claim 6 wherein the sample content comprises trailers and product reels associated with films which are seeking theatrical distribution status.

8. The method as recited in claim 1 wherein the content is selected by a content review group from amongst content submitted to the group by content creators, distributors, or creator/distributors.

9. The method as recited in claim 8 wherein the sample content is selected by the content review group.

10. The method as recited in claim 9 wherein the sample content is produced by:
i. the content creator;
ii. the content distributor;
iii. the content review group; or
iv. any two or more of these entities working together.

11. The method as recited in claim 8 wherein the content creator is a filmmaker, and the content distributor is a movie studio.

12. The method as recited in claim 1 wherein said method has the effect of increasing the number of individual pieces of full-length content exhibited to consumers in a given venue in a given period of time.

13. The method as recited in claim 1, wherein said method has the effect of increasing average attendance of an exhibition at an exhibition venue.

14. The method as recited in claim 13 wherein said method has the effect of reducing the advertising expenditure by a distributor or an exhibitor required to achieve an equivalent level of attendance of an exhibition of the content.

15. The method as recited in claim 14 wherein said content is a film and said exhibition venue is a movie theater.

16. A system for distributing content to consumers, comprising:
i. an internet community network in which a individual consumers having internet access become members of the network by establishing individual profiles on the network;
ii. a first library of content for provision to exhibitors;
iii. a second library of sample content associated with the first library of content for provision to, and available for perception of and indication of preference for, the internet community network;
iv. a plurality of digital projectors, each in an exhibition venue, linked electronically to said first library; and
v. a functionality for electronically disseminating content to each individual digital projector or exhibition venue.

17. A method of financing the implementation of digital projection capability in a plurality of theaters, comprising the steps of:
i. providing to a plurality of exhibitors digital projection systems for implementation in their theaters, and access to a content library;
ii. charging of a per-screening usage fee to exhibitors each time content from the content library is exhibited via the digital projection system; and
iii. reinvestment of the proceeds from the accumulated fees into a fund for further provision of digital projection systems to subsequent exhibitors;
wherein said method results in an increase in the rate of implementation of digital projection capability in theaters.

18. The method as recited in claim 17, wherein said method permits theaters which would not otherwise be able to afford to implement digital projection capability to do so.

19. The method as recited in claim 17, wherein said method additionally results in an increase in the quantity or diversity of content available to theaters which have implemented digital projection systems.

20. A system for advertising to a targeted audience, comprising at least one computer which uses psychographic and demographic data gained from one or more online sources to target advertising in a venue.

21. The system as recited in claim 20, wherein said venue is an offline venue

22. The system as recited in claim 20, wherein said offline venue is chosen from a television screen, a movie screen, a billboard, and a virtual environment.

23. The system as recited in claim 20, wherein the advertisement is targeted to a specific individual present in the offline venue where the ad is shown.

24. A system for advertising to a targeted audience, comprising at least one computer having:
a means for determining the brand landscape in a venue at a given time; and
a means for selecting of content or advertising for presentation to the targeted audience.

25. The system as recited in claim 24, wherein said venue is an offline venue.

26. The system as recited in claim 24, wherein said offline venue is chosen from a theater, a billboard, and a virtual environment.

27. The system as recited in claim 26, wherein the presentation of content or advertising to the user is via a movie screen and occurs:
before the content which the audience has come to see;
during the content which the audience has come to see, via brand integration; or in the lobby.

28. A method of progressive licensing encumbrance, comprising:
the joining of a content owner a community network comprising a plurality of members who are content consumers;
the granting of an initial level of rights in an article of content in exchange for an initial level of exposure via the internet community network; and
as popularity increases to each of one or more pre-determined levels, the attachment of additional rights for additional exposure, wherein said popularity of the content is determined by the community network.

29. The method as recited in claim 28, wherein said additional rights are chosen from certain theatrical exhibition rights, all theatrical exhibition rights, and home-distribution media rights.

30. The method as recited in claim 28, wherein said home-distribution media rights are chosen from DVD distribution media rights, television rights, and video game rights.
